(19) United States
(12) Patent Application Publication
(10) Pub. No.: US 2026/0160470 A1
(43) Pub. Date: Jun. 11, 2026

(54) ICE MAKER APPLIANCE AND INTERIOR ACCESSIBILITY STRUCTURE

(71) Applicant: Haier US Appliance Solutions, Inc., Wilmington, DE (US)

(72) Inventors: Zhihua Liu, Louisville, KY (US); Ruochong Song, Louisville, KY (US)

(21) Appl. No.: 18/976,788

(22) Filed: Dec. 11, 2024

(51) Int. Cl. F25C 1/25; B01D 35/027; B01D 35/157; C02F 1/00; F25C 5/182

(52) U.S. Cl. CPC F25C 1/25; B01D 35/027; B01D 35/1573; C02F 1/001; C02F 1/008; F25C 5/182; C02F 2201/005; C02F 2209/42; F25C 2400/14; F25C 2700/04

(57) ABSTRACT

An ice maker appliance includes a cabinet having a plurality of walls forming an interior and having an articulatable door. A reservoir includes a supply inlet opening and an ice engine supply opening and forms a receiving plenum at which water is received from a supply inlet opening. The reservoir is at least partially housed at the interior of the cabinet. A water level sensor is configured to determine a water height at the reservoir. A water supply conduit fluidly couples the reservoir to the ice engine. A water filter is positioned at the reservoir and fluidly upstream of the water supply conduit and ice engine. A reservoir supply conduit fluidly couples the reservoir to a main water supply and a flow control device. A flow control device is operably coupled to the water level sensor to selectively permit flow of water to the reservoir based on the water height.

### FIELD OF THE INVENTION

The present subject matter relates generally to ice maker appliances, and particularly to standalone ice maker appliances, such as nugget ice makers.

### BACKGROUND OF THE INVENTION

Ice maker appliances, such as nugget ice makers and standalone ice maker appliances, include tubes that receive water at, and drain water from, the ice maker, and fluidly connect components of the ice maker appliance, such as between a reservoir and an ice engine for producing ice.

However, draining, cleaning, removing, or replacing such tubes can be difficult due to accessibility. For instance, tubes may be positioned within housings that are not generally intended for regular access. For example, access to the tubes may require removing fasteners (e.g., screws, bolts, etc.) using a tool to enter an internal volume of the ice maker.

Additionally, or alternatively, tubes may be located thermally proximate to heat sources, such as a heat exchanger for producing ice. Thermal proximity of the tubes can promote environmental conditions for generating mold, mildew, bacteria, viruses, scaling, or corrosion at the tube. Such conditions at a water supply tube to a reservoir or ice engine can lead to poor quality water being used for producing ice. Furthermore, mitigating such conditions by cleaning or replacement may be inhibited by poor or difficult access to the tubes.

Accordingly, an ice maker appliance that overcomes one or more of these issues would be beneficial and advantageous. Additionally, an ice maker appliance and method for operation that overcomes one or more of these issues would be beneficial and advantageous.

### BRIEF DESCRIPTION OF THE INVENTION

Aspects and advantages of the invention will be set forth in part in the following description, or may be obvious from the description, or may be learned through practice of the invention.

An aspect of the present disclosure is directed to an ice maker appliance. The ice maker appliance includes a cabinet including a plurality of walls forming an interior, wherein at least one of the plurality of walls includes an articulatable door. An ice engine includes a water supply opening. A reservoir includes a body, the body having a side wall and a base wall. A supply inlet opening and an ice engine supply opening are formed through the body. The body forms a receiving plenum at which water is received from the supply inlet opening. The reservoir is at least partially housed at the interior of the cabinet. A water level sensor configured to determine a water height at the reservoir. A water supply conduit fluidly couples the reservoir to the ice engine. The water supply conduit fluidly couples from the ice engine supply opening to the water supply opening. A water filter is positioned at the reservoir. The water filter is positioned fluidly upstream of the water supply conduit and the ice engine supply opening. A reservoir supply conduit fluidly couples the reservoir to a main water supply and a flow control device. The flow control device is operably coupled to the water level sensor to selectively permit flow of water through the reservoir supply conduit to the reservoir based on the water height at the reservoir.

An aspect of the present disclosure is directed to an ice maker appliance. A cabinet includes a plurality of walls forming an interior, wherein at least one of the plurality of walls includes an articulatable door. An ice engine includes a water supply opening. A reservoir includes a body, the body having a side wall and a base wall. A supply inlet opening, a drain opening, and an ice engine supply opening are formed through the body. The body forms an upper receiving plenum at which water is received from the supply inlet opening. The reservoir is at least partially housed at the interior of the cabinet. A water level sensor is configured to determine a water height at the reservoir. A water supply conduit fluidly couples the reservoir to the ice engine. The water supply conduit fluidly couples from the ice engine supply opening to the water supply opening. A water filter is positioned at the reservoir. The water filter is positioned fluidly between the upper receiving plenum and a drain opening. The drain opening is fluidly coupled to a lower receiving plenum at which filtered water is received from the drain opening. A reservoir supply conduit fluidly couples the reservoir to a main water supply and a flow control device. The flow control device is operably coupled to the water level sensor to selectively permit flow of water through the reservoir supply conduit to the reservoir based on the water height at the reservoir.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 depicts a schematic embodiment of an ice maker appliance in accordance with aspects of the present disclosure.

FIG. 2A depicts a schematic embodiment of an ice maker appliance in accordance with aspects of the present disclosure.

FIG. 2B depicts a partially exploded view of an embodiment of an ice maker appliance in accordance with aspects of the present disclosure.

FIG. 3 depicts a schematic embodiment of an ice maker appliance in accordance with aspects of the present disclosure.

FIG. 4 depicts a perspective view of an embodiment of a water filter for an ice maker appliance in accordance with aspects of the present disclosure.

FIG. 5 depicts a perspective cutaway view of an embodiment of an upper reservoir, including an embodiment of the water filter, for an ice maker appliance in accordance with aspects of the present disclosure.

FIG. 6 depicts a perspective cutaway view of an embodiment of an upper reservoir, including an embodiment of the water filter, for an ice maker appliance in accordance with aspects of the present disclosure.

FIG. 7 depicts a perspective view of portions of an embodiment of an ice maker appliance in accordance with aspects of the present disclosure.

FIG. 8 depicts a perspective view of portions of the embodiment of the ice maker appliance of FIG. 7 in accordance with aspects of the present disclosure.

FIG. 9 depicts a perspective view of portions of the embodiment of the ice maker appliance of FIG. 7, including an embodiment of a water filter, in accordance with aspects of the present disclosure.

FIG. 10 depicts a schematic embodiment of an articulatable top panel of an upper reservoir for an ice maker appliance in accordance with aspects of the present disclosure.

FIG. 11 depicts a schematic embodiment of an ice maker appliance in accordance with aspects of the present disclosure.

FIG. 12 depicts a partially exploded view of an embodiment of an ice maker appliance in accordance with aspects of the present disclosure.

FIG. 13 depicts a perspective view of portions of the embodiment of the ice maker appliance of FIG. 12 in accordance with aspects of the present disclosure.

FIG. 14 depicts a perspective view of an articulatable door in a closed position of an embodiment of an ice maker appliance in accordance with aspects of the present disclosure.

FIG. 15 depicts a perspective view of the articulatable door in an open position of the embodiment of the ice maker appliance of FIG. 14 in accordance with aspects of the present disclosure.

FIG. 16 depicts a perspective view of portions of an embodiment of an ice maker appliance in accordance with aspects of the present disclosure.

FIG. 17 depicts a rear view of the ice maker appliance of FIG. 16 in accordance with aspects of the present disclosure.

FIG. 18 depicts a side view of the ice maker appliance of FIG. 16 in accordance with aspects of the present disclosure.

FIG. 19 depicts a side view of portions of an embodiment of the ice maker appliance, including a cabinet including an articulatable panel in a closed position, in accordance with aspects of the present disclosure.

FIG. 20 depicts an embodiment of the ice maker appliance, including the articulatable panel in an open position, in accordance with aspects of the present disclosure.

FIG. 21 depicts a schematic embodiment of an ice maker appliance in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

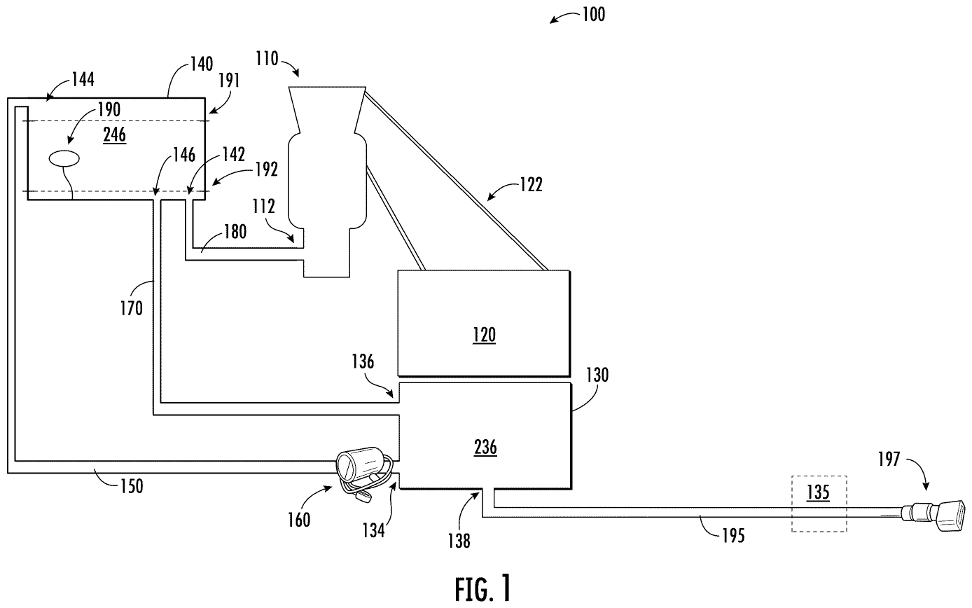

Embodiments of an ice maker appliance overcoming one or more of the aforementioned issues are provided. Referring to FIG. 1, a schematic embodiment of an ice maker appliance 100 is provided. The appliance 100 includes an ice engine 110 configured to produce ice. The ice engine 110 includes components generally understood for producing ice, such as, but not limited to, a heat exchanger for removing heat to produce ice, and a mechanism for moving ice to a container, such as an ice storage vessel 120. For instance, a tray, ramp, or chute 122 may provide a surface positioned to receive ice from the ice engine 110 and extending to deposit ice to the ice storage vessel 120. The ice engine 110 may include an auger for forming, shaving, or moving desired pieces of ice. The ice engine 110 may include trays for holding and molding pieces of ice into desired shapes. In particular embodiments, the ice engine 110 is configured as a nugget ice maker engine, such as configured to produce relatively small, soft, chewable ice compacted from ice shavings.

Various embodiments of ice engine 110 include a water supply opening 112 configured to receive water for producing ice. The ice engine 110 may include a flow control device, such as a flow control device or valve, configured to selectively articulate to receive water through the water supply opening 112 for producing ice.

The appliance 100 includes an upper reservoir 140 having an ice engine supply opening 142 and a water supply inlet opening 144. A water supply conduit 180 fluidly couples the upper reservoir 140 to the ice engine 110 to supply water to the ice engine 110 for producing ice. The water supply conduit 180 fluidly couples from the ice engine supply opening 142 at the upper reservoir 140 to the water supply opening 112 at the ice engine 110.

In various embodiments, the appliance 100 includes a lower reservoir 130 forming a receiving plenum 236 at which a user may deposit water for producing ice. The lower reservoir 130 includes a water supply outlet opening 134 and a return opening 136 in fluid communication with the receiving plenum 236. In various embodiments, an upper reservoir supply conduit 150 fluidly couples the lower reservoir 130 to the upper reservoir 140. The upper reservoir supply conduit 150 fluidly couples from the supply outlet opening 134 and receiving plenum 236 at the lower reservoir 130 to the supply inlet opening 144 and a receiving plenum 246 at the upper reservoir 140. In various embodiments, the return opening 136 at the lower reservoir 130 is positioned at a greater height than the supply outlet opening 134.

In various embodiments, a flow control device 160 is configured to selectively feed water through the upper reservoir supply conduit 150 from the lower reservoir 130 to the upper reservoir 140.

In some embodiments, the upper reservoir 140 includes a drain opening 146. A drain conduit 170 fluidly couples the upper reservoir 140 to the lower reservoir 130. The drain conduit 170 fluidly couples from the drain opening 146 at the upper reservoir 140 to the return opening 36 at the lower reservoir. The drain conduit 170 is configured to gravitationally feed water from the drain opening 146 at the upper reservoir 140 to the return opening 136 at the lower reservoir 130.

The upper reservoir 140 is positioned along a vertical direction relative to the lower reservoir 130 such that a plenum at the upper reservoir 140 at which water is received and stored is positioned to permit gravitational flow downward to the lower reservoir 130. Gravitational feeding of water from the upper reservoir 140 to the lower reservoir 130 is provided free of a fluid flow control device urging water from the upper reservoir 140 to the lower reservoir 130. For instance, various embodiments of the appliance 100 are configured without a pump, nozzle, valve, or other device configured to urge, push, actuate, or feed water from the drain opening 146 to the return opening 136 greater than a flow rate corresponding to gravitationally feeding water. As such, appliance 100 may be free of a flow control device from the drain opening 146 to the return opening 136. A flow path of the appliance 100 extending from the upper reservoir 140 to the lower reservoir 130 (e.g., through the drain conduit 170) may be configured as a passive system without actuating or articulating components. As a flow control device, such as a pump or valve, may generally provide a variable geometry or flow area along a volume extending from an upper reservoir to a lower reservoir, embodiments of the appliance 100 provided herein may include the drain conduit 170 having a substantially constant flow area from the drain opening 146 at the upper reservoir 140 to the return opening 136 at the lower reservoir 130.

The flow control device 160 may be configured to permit flow through the upper reservoir supply conduit 150 from the upper reservoir 140 to the lower reservoir when the flow control device 160 is deactivated. For instance, the flow control device 160 may include a centrifugal flow control device or any appropriate type of flow control device permitting back flow in a deactivated state.

In various embodiments, appliance 100 includes a water level sensor 190 configured to determine a water height at the upper reservoir 140, the lower reservoir 130, or both. The water level sensor 190 may include any appropriate float sensor or float switch. For instance, the water level sensor 190 may generally include an actuatable rod or member connected to a floatation device. Movement of the floatation device with the water level articulates the rod or member. Water height corresponds to the position of the floatation device, and changes in water height translate into changes in position of the articulatable rod or member. Changes in the position of the rod or member are coupled to a sensor or switch operably coupled to a flow control device (e.g., a pump or valve, such as flow control device 160) configured to selectively permit or inhibit flow of water to the upper reservoir 140.

In still various embodiments, the supply inlet opening 144 is positioned at the upper reservoir 140 at a height (e.g., along a vertical direction) greater than a maximum water level height 191 corresponding to the water level sensor 190 at the upper reservoir 140.

In some embodiments, the water level sensor 190 is operably coupled to the flow control device 160. As described herein, the flow control device 160 is operably coupled to the flow control device 160 to activate (e.g., articulate, open, energize, etc.) to supply water from the lower reservoir 130 to the upper reservoir 140 when the water level sensor 190 articulates, translates, or otherwise determines a water height at the upper reservoir 190 at or less than a minimum water level height 192. For instance, a flow sensor or switch at the flow control device 190 may be operably coupled to a member operably or communicatively coupled to the flow control device 160 to permit flow of water from the lower reservoir 130 to the upper reservoir 140 when the water height (e.g., a flotation device at the water level sensor 190) is at or below the minimum water level height 192. The flow control device 190 may further be configured to deactivate (e.g., articulate, close, de-energize, etc.) to discontinue supplying water from the lower reservoir 130 to the upper reservoir 140 when the water level sensor 190 articulates, translates, or otherwise determines the water height at the upper reservoir 140 at or greater than the maximum water level height 191.

In various embodiments, the upper reservoir supply conduit 150 and the supply outlet opening 134 at the lower reservoir 130 are configured to provide a greater flow rate to the lower reservoir 130 when the flow control device 160 is deactivated (i.e., discontinued from pulling water from the lower reservoir 130 to the upper reservoir 140) than gravitational feed of water from the drain opening 146 at the upper reservoir 140 to the return opening 136 at the lower reservoir 130. For instance, a geometry corresponding to flow rate across the drain opening 146, or a drain flow path at least in part from the drain opening 146 to the return opening 136, such as flow area, is less than a corresponding geometry (e.g., flow area) at the upper reservoir supply conduit 150, or a supply flow path from the supply outlet opening 134 to the supply inlet opening 144.

The appliance 100 includes drain opening 146, drain conduit 170, and return opening 136 configured to continuously permit flow of water from the upper reservoir 140 to the lower reservoir 130. Appliance 100 may enter into an idle mode after a period without interaction from a user (e.g., without having ice removed or generated). The idle mode can inhibit flow of water through upper reservoir supply conduit 150, or commands for water supply therethrough. For instance, idle mode may inhibit supply water based on a minimum water level at the upper reservoir 140. After a period of time in the idle mode, without water being pulled from the lower reservoir 130 to the upper reservoir 140 through upper reservoir supply conduit 150, water at the upper reservoir supply conduit 150 will drain back to the lower reservoir 130, permitting the upper reservoir supply conduit 150 to become dry and mitigate growth of undesired mold, mildew, bacteria, scaling, or viruses, or inhibit corrosion of the conduit 150. Water from the upper reservoir 140 may further drain through the drain opening 146 to the lower reservoir 130, permitting the upper reservoir 140 to become dry.

Referring still to FIG. 1, in various embodiments, the appliance 100 includes a lower reservoir egress conduit 195. The lower reservoir egress conduit 195 may form a drain conduit (e.g., to a sink or other disposal) or flow path to a second reservoir 135 positioned adjacent to the lower reservoir 130, such as forming a side tank. In such embodiments, the lower reservoir egress conduit 195 fluidly couples the lower reservoir 130 at an egress opening 138 to the second reservoir 135. The lower reservoir egress conduit 195 may include a quick-release fitting or valve 197, facilitating user articulation of flow from the lower reservoir egress conduit 195 (e.g., to the second reservoir 135, to a drain, or to a user as a water dispenser). Lower reservoir 130, upper reservoir 140, or both, may form a first reservoir at which water is filtered and provided to the second reservoir 135 as a filtered water tank.

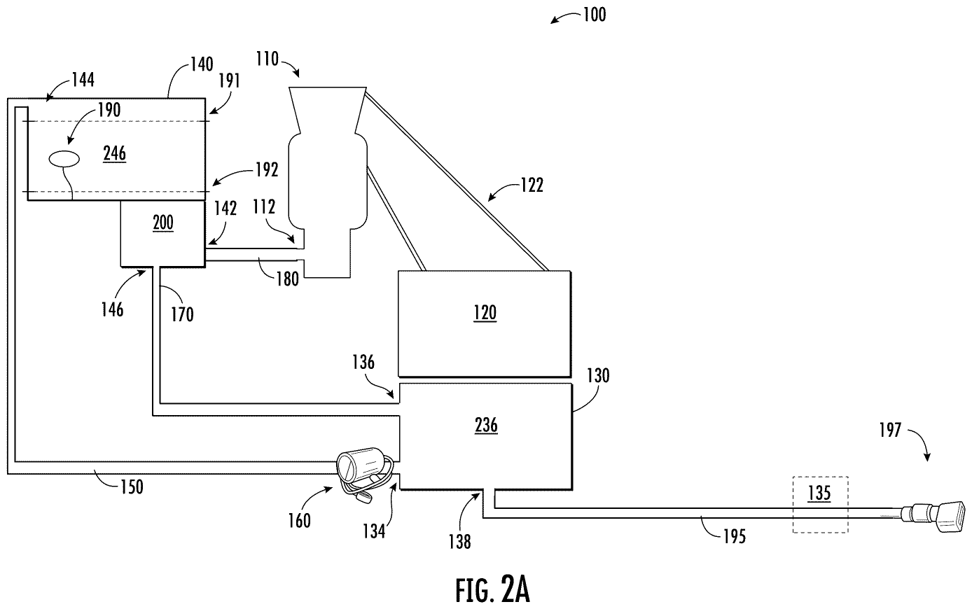

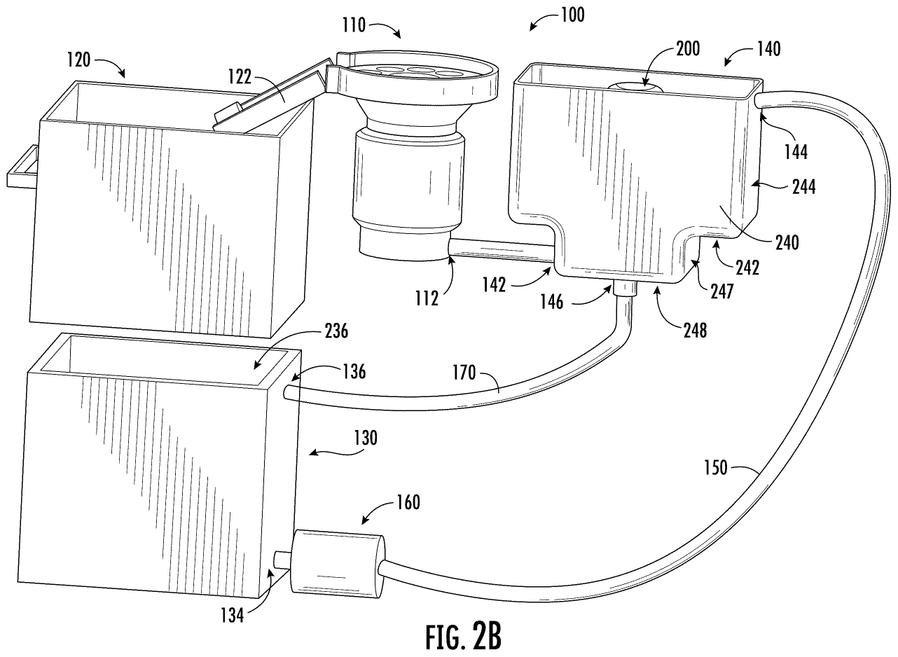

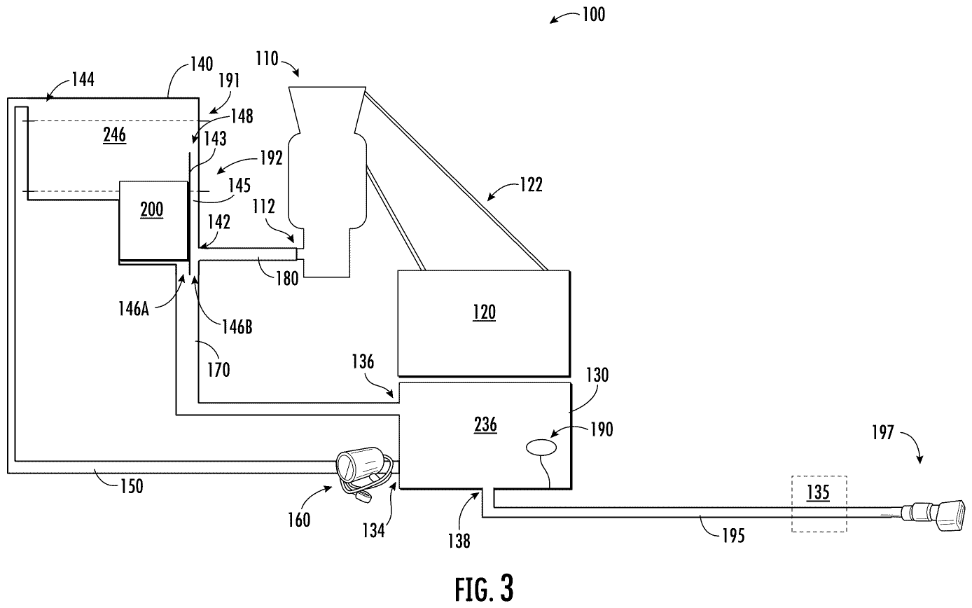

Referring now to FIGS. 2A-2B and FIG. 3, embodiments of an ice maker appliance 100 are provided. FIG. 2A and FIG. 3 depict schematic embodiments of an appliance 100. FIG. 2B depicts a partially exploded view of components of an embodiment of the appliance 100. Appliance 100 depicted in FIGS. 2A-2B and FIG. 3 are configured substantially as described in regard to one or more embodiments of FIG. 1. In FIGS. 2A-2B and FIG. 3, the appliance 100 further includes a water filter 200 positioned at the upper reservoir 140. The water filter 200 is positioned fluidly upstream of the ice engine supply opening 142 and the ice engine 110, such as to provide filtration of water from the upper reservoir 140 flowing to the ice engine 110. The water filter 200 may include a gravity water filter in which water from the upper reservoir 140 flows substantially downward through a filtration medium at the water filter 200 and to the ice engine supply opening 142 and supply conduit 180 to the ice engine 110. The water filter 200 may additionally be configured for water to flow from the upper reservoir 140 substantially downward through the filtration medium at and to the drain opening 146 and drain conduit 170.

In various embodiments, the appliance 100 is free of a filter positioned at the lower reservoir 130 or between the flow control device 160 and the lower reservoir 130 (i.e., free of a filter fluidly upstream relative to a flow direction of water via the flow control device 160 from the lower reservoir 130 to the upper reservoir 140). Positioning the water filter 200 at the upper reservoir 140 may remove a need for a water filter at the lower reservoir 130, or fluidly proximate thereto. Removing a water filter from the lower reservoir 130, or from along a flow path from the lower reservoir 130 to the flow control device 160, may remove flow restrictions that can require configurations, flow or power ratings, back pressures or pressure differentials, or geometries at the flow control device 160 that may prevent backflow of water from the upper reservoir supply conduit 150 to the lower reservoir 130 when the flow control device 160 is deactivated or discontinued from urging flow toward the upper reservoir 140. For instance, some embodiments of a flow control device forming a diaphragm pump may inhibit backflow to the lower reservoir, which may cause water to remain in a feed conduit from a lower reservoir to an upper reservoir, which can facilitate undesired growth of mold, mildew, bacteria, viruses, scaling, or corrosion at the feed conduit.

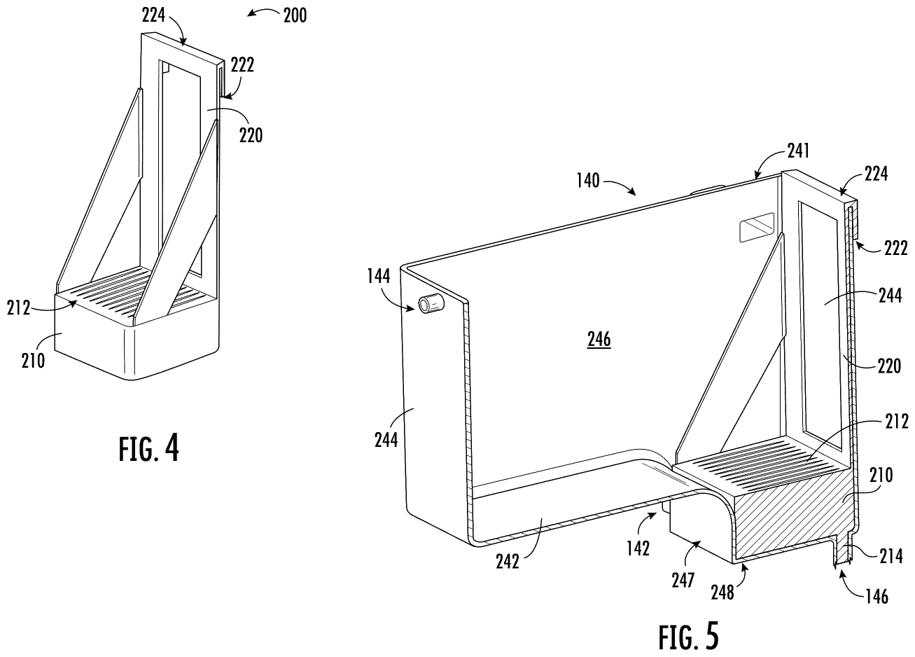

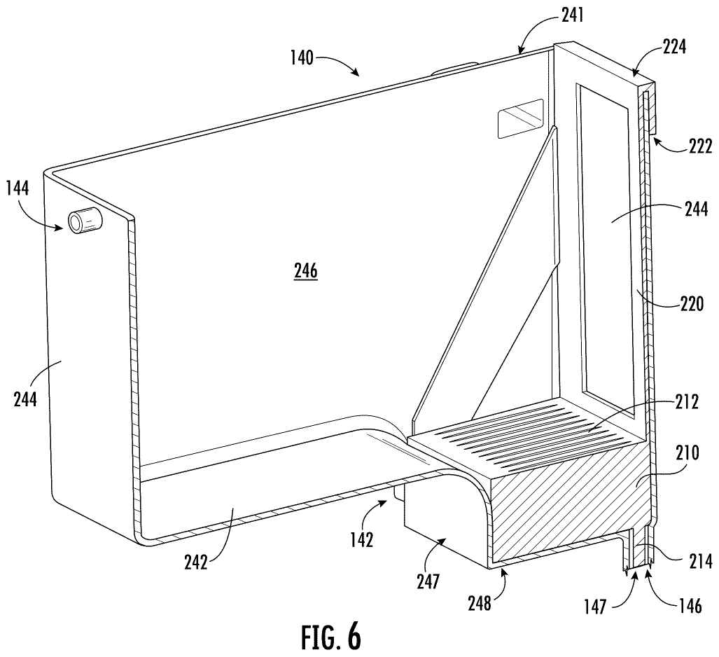

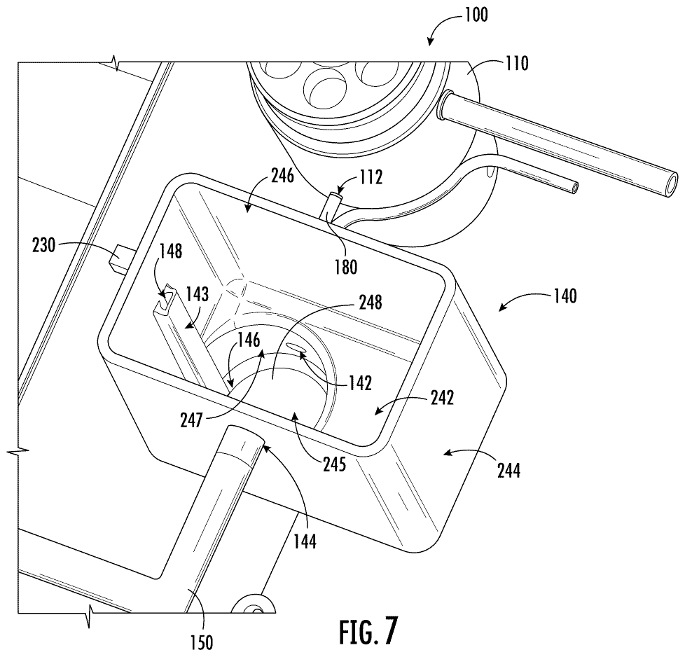

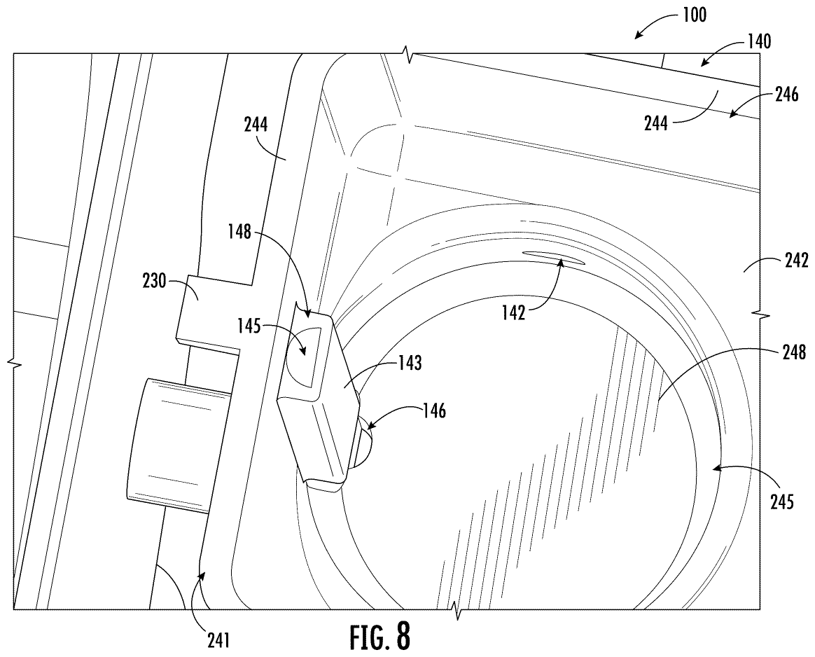

Referring now to FIGS. 4-9, exemplary embodiments of a water filter 200 and an upper reservoir 140 are provided. FIG. 4 provides a perspective view of an embodiment of the water filter 200. FIGS. 5-6 provide exemplary cutaway perspective views of an embodiment of the water filter 200 positioned in an embodiment of the upper reservoir 140. FIG. 7-9 provide exemplary perspective views of an embodiment of the upper reservoir 140 with and without an embodiment of the water filter 200.

In various embodiments, the upper reservoir 140 includes a body 240 including a base wall 242 and a plurality of side walls 244. A door or top panel 243 extends over the plurality of side walls 244, such as to enclose the receiving plenum 246 formed between the plurality of side walls 244 and the base wall 242. Water supply inlet opening 144 is formed through at least one of the side walls 244. Water from the water supply inlet opening 144 is provided into the upper reservoir 140 at the receiving plenum 246. In various embodiments, the ice engine supply opening 142 and the drain opening 146 are formed through the body 240.

In various embodiments, the water filter 200 includes a filter body 210 at which a filtration medium 212 is positioned. The filtration medium 212 includes any appropriate type of material, substrate, or composition, such as, but not limited to, activated charcoal, catalytic carbon, sand, gravel, resin, polymers, or combinations thereof. The filtration medium 212 may include electrically-driven filter media or apparatuses.

In still various embodiments, a member 220 extends from the filter body 210 and positions a sensing interface 222 at a wall (e.g., wall 242, 243, 244) of the upper reservoir 140 in sensing proximity to a filter sensor 230 (FIGS. 7-9). The member 220 may extend substantially along a vertical direction, such as from the filter body 210 toward a door or top panel 243 of the upper reservoir 140.

The filter sensor 230 may be positioned outside of the body 240. The filter sensor 230 may abut an outside surface of the body 240, or position with a gap between the filter sensor 230 and the body 240. The filter sensor 230 may include any appropriate device for determining presence or proximity of a member. In some embodiments, the filter sensor 230 includes a proximity sensor having an inductive, magnetic, or capacitive sensor configured to magnetically or electromagnetically communicate with at least a portion of the member 220 having an appropriate sensing material, such as a metallic or ferrous material at the sensing interface 222. For instance, the filter sensor 230 may be electrically coupled to a power source or controller permitting electromagnetic communication of the filter sensor 230 to the sensing interface 222 inside or outside of the upper reservoir 140.

Referring to FIGS. 4-6, in some embodiments, the member 220 forms a hanger configured to extend around an upper lip 241 of the upper reservoir 140. The member 220 may form a hanger including a latch, curl, or hook 224 configured to extend over the upper lip 241. The member 220 forming a hanger may position the sensing interface 222 outside of the upper reservoir 140 to position the sensing interface 222 proximate to the filter sensor 230. The member 220 forming the hanger may position the sensing interface 222 outside of the receiving plenum 246.

Referring to FIGS. 7-9, in some embodiments, the member 220 extends toward the side wall 244 to position the sensing interface 222 within the upper reservoir 140 proximate to the filter sensor 230.

Embodiments of the upper reservoir 140 and filter sensor 230 may determine presence of the water filter 200 at the upper reservoir 140 without requiring electrical or electronic components or wires to extend through one or more, or all, of wall 242, 243, 244 of the upper reservoir 140. In some embodiments, the body 240 of the upper reservoir 140 is free of electrical or electronic components extending through the body 240 (e.g., extending through one or more walls 242, 243, 244) into the receiving plenum 246.

Referring back to FIGS. 5-6, in various embodiments, the filter body 210 may include a plug or metering member 214 extendable from the filter body 210 into the drain opening 146 at the upper reservoir 140. In various embodiments, the member 214 extends vertically downward from the filter body 210 to extend into the drain opening 146. A user may articulate the water filter 200 along the vertical direction to position the water filter 200 at the upper reservoir 140, or pull the water filter 200 along the vertical direction to remove the water filter 200 from the upper reservoir 140. The user may furthermore articulate the water filter 200 along the vertical direction to position the member 214 into the drain opening 146, or remove the member 214 from the drain opening 146.

Referring to FIG. 5, the member 214 forms a plug extending into the drain opening 146 to prohibit flow through the drain opening 146 into the drain conduit 170. The member 214 extending from the filter body 210 may correspond in geometry to the drain opening 146 to prohibit flow from the upper reservoir 140 into the drain conduit 170.

Referring to FIG. 6, the member 214 forms a metering member extending into the drain opening 146 to inhibit flow through the drain opening 146 into the drain conduit 170, such as to provide a metered flow rate of water from the upper reservoir 140 through the drain conduit 170. A geometry of the member 214 may be configured relative to the drain opening 146 to adjust a flow area to the drain conduit 170, such as to produce a flow rate through the drain conduit 170 less than a flow rate at the upper reservoir supply conduit 150. For instance, member 214 may extend into the drain opening 146 and form a gap 147 between the member 214 and surrounding walls at the reservoir 140.

Referring to FIG. 2B and FIGS. 5-9, the upper reservoir 140 may include a water filter plenum 245 at which the water filter 200 is received into the upper reservoir 140. The water filter plenum 245 may extend into the base wall 242 to form a pocket at which the water filter 200 is positioned at the upper reservoir 200. The upper reservoir 140 may include a plenum side wall 247 and a plenum base wall 248 forming the water filter plenum 245. In various embodiments, walls 247, 248 extend from the base wall 242, such as downward along the vertical direction and forming a trough into the base wall 242. The ice engine supply opening 142 and drain opening 146 may extend through the plenum side wall 247 or the plenum base wall 248. As such, the water filter 200 is disposable in fluid arrangement between the receiving plenum 246 and the ice engine supply opening 142, the drain opening 146, or both.

Referring back to FIG. 3, and further depicted in FIGS. 5-9, in various embodiments, the upper reservoir 140 includes a flow separation wall 143 extending from the drain opening 146 and into the receiving plenum 246. The flow separation wall 143 forms a bypass passage 145 extending from a bypass inlet opening 148 to the drain opening 146. The bypass passage 145 fluidly bypasses the water filter 200 from the receiving plenum 246 to the drain opening 146.

The bypass inlet opening 148 is positioned at a height at the receiving plenum 146 greater than the filter body 210 of the water filter 200. In various embodiments, the bypass inlet opening 148 is positioned at the height at the receiving plenum 146 less than a vertical position the water supply inlet opening 144.

Referring to FIG. 3, in some embodiments, the drain opening 146 includes a first drain opening 146A fluidly downstream of the water filter 200, such as in fluid communication with the water filter 200 to receive filtered water from the water filter 200. The drain opening 146 may further include a second drain opening fluidly downstream of the bypass passage 145, such as forming an end of the bypass passage 145 fluidly bypassing the water filter 200. Drain openings 146A, 146B may together fluidly connect to the drain conduit 170. For instance, drain openings 146A, 146B may fluidly couple to the lower reservoir 130, such as described herein in regard to drain opening 146.

In some embodiments, the flow separation wall 143 may include a tube, manifold, or conduit extending from the drain opening 146 and positioned to receive water from the receiving plenum 246. In still some embodiments, referring to FIGS. 7-9, the flow separation wall 143 extends along an inner wall of the upper reservoir 140 to the water filter plenum 245 at which the water filter 200 is disposed. For instance, referring to FIGS. 7-9, the flow separation wall 143 may extend along the plenum side wall 247, the side wall 244, or both. The flow separation wall 143 may be formed integrally with the body 240 as a unitary, monolithic component.

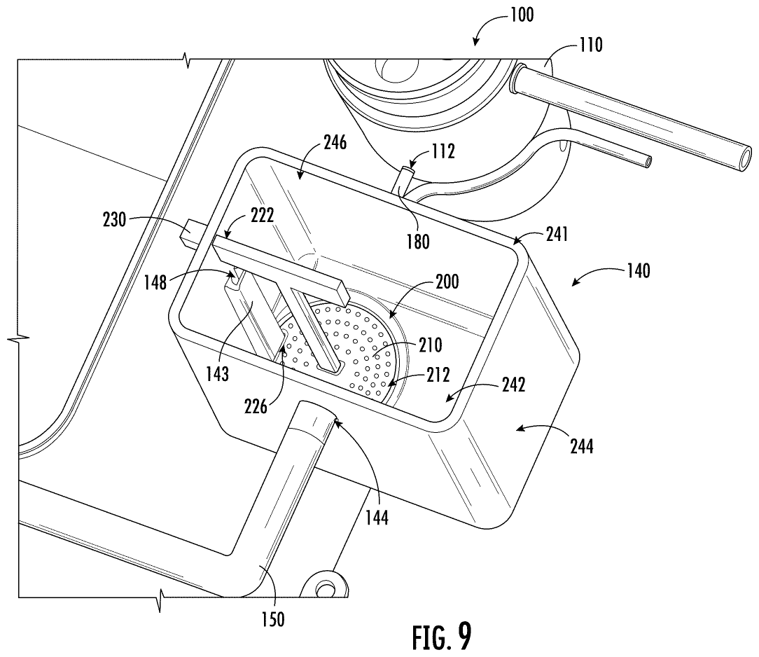

The flow separation wall 143 may additionally form a raised surface at the water filter plenum 245. The water filter 200, such as the filter body 210, may include a notch 226 (FIG. 9) corresponding to the flow separation wall 143. As such, raised surface of the flow separation wall 143 at the water filter plenum 245 may form a clocking or orienting feature of the water filter 200 into the water filter plenum 245, such as may position the member 220 or sensing interface 222 in operable arrangement with the filter sensor 230.

Embodiments of the flow separation wall 143 and bypass passage 145 may form an overflow port permitting flow of water from the upper reservoir 140 to the drain conduit 170 without requiring flow through the water filter 200. The overflow port can facilitate removing a float sensor or water level sensor from the upper reservoir 140. As such, various embodiments of the appliance 100 may prevent overflow at the upper reservoir 140 without requiring electrical or electronic components or wires to extend through one or more, or all, of wall 242, 243, 244 of the upper reservoir 140. In some embodiments, the body 240 of the upper reservoir 140 is free of electrical or electronic components extending through the body 240 (e.g., extending through one or more walls 242, 243, 244) into the receiving plenum 246.

In an exemplary embodiment of a method for operating the appliance 100, the flow control device 160 operates to flow water to the upper reservoir 140 when, or before, the ice engine 110 operates to produce ice. For instance, the ice engine 110 operates to receive water from the upper reservoir 140, and further operates a cooling system (e.g., a heat exchanger) to generate ice. A shutdown operation may include discontinuing the cooling system then discontinuing operation of the ice engine 110, the flow control device 160, or both.

In an exemplary embodiment of a method for operating the appliance 100, a circulation or cleaning mode may include cycling or pulsing flow through or from the flow control device 160. The ice engine 110 can receive and circulate water with the cooling system remaining off. Water flows from the lower reservoir 130 to the upper reservoir 140. As flow across the water filter 200 may slow a flow rate to the drain opening 146, water may accumulate in the receiving plenum 246 until the water level height rises to the bypass inlet opening 148 and through the bypass passage 145 to the drain conduit 170 and to the lower reservoir 130. The second drain opening 146B and drain conduit 170 may be sized to permit a flow rate to the lower reservoir 130 facilitating circulation such as described. The first drain opening 146A may be sized such as described herein to meter or prohibit flow such as described herein. In various embodiments, the first drain opening 146A is configured to feed water from the first drain opening 146A to the drain conduit 170 at a first flow rate less than a second flow rate corresponding to the second drain opening 146B configured to feed water from the second drain opening 146B to the drain conduit 170. In still various embodiments, the member 214 extending from the filter body 210 is configured to extend into the first drain opening 146A and permit a first flow rate of water from the upper reservoir 140 through the first drain opening 146A to the drain conduit 170. The first flow rate is less than a second flow rate corresponding to the second drain opening 146B (e.g., without member 214 extending thereinto) configured to feed water from the second drain opening 146B to the drain conduit 170.

The circulation or cleaning mode may activate after a predetermined quantity of ice engine operation (e.g., ice production) cycles or hours, or after a predetermined period of time in an idle mode, such as may inhibit growth of mold, mildew, bacteria, viruses, scaling, or corrosion. In still some embodiments, the flow control device 160, the ice engine 110, or both, may be communicatively coupled to the water level sensor 190 at the lower reservoir 130, such as may prevent overflow or overfill of water at the lower reservoir 130 by selectively operating the flow control device 160 to remove water from the lower reservoir 130 to the upper reservoir 140.

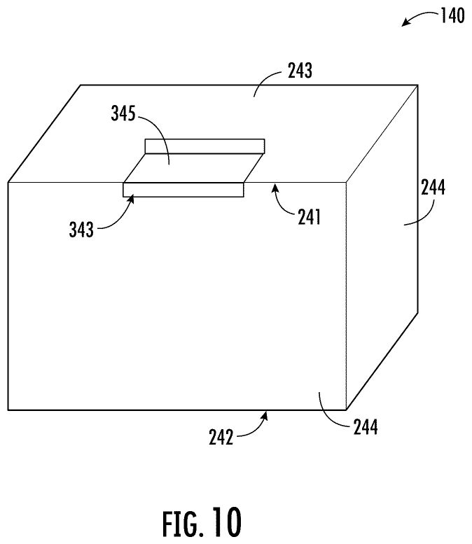

Referring now to FIG. 10, an embodiment of the upper reservoir 140 including an articulatable door or top panel 243 is provided. The articulatable top panel 234 permits selective access into the upper reservoir 140, such as into the receiving plenum 246. For instance, the upper reservoir 140 may include the body 240 including walls 242, 244, or furthermore, plenum walls 247, 248, forming an integral, unitary, monolithic component. Top panel 243 may form a separable component, such as a lid, window, or door, disposable over the upper lip 241 of the body 240.

In some embodiments, the top panel 243 may include a window or door 345 permitting selective access into the upper reservoir 140, such as into the receiving plenum 246. The top panel 243 may be formed integrally with the body 240, and the door 345 may form a separable component disposable to the top panel 243. A hinge 343 may connect the door 345 to the top panel 234 in rotatable connection. In other embodiments, the door 345 may be positioned in sliding arrangement to the top panel 243.

Embodiments of the upper reservoir 140 may facilitate the water filter 200 to operably couple to the water filter sensor 230 without requiring extension of electrical or electronic components through side walls 244, base wall 242, or plenum walls 247, 248 of the body 240. For instance, filter sensor 230 may mount to, or through, the top panel 243, such as at door 343, in operable communication with the member 220 or sensing interface 222 at the water filter 200.

In some embodiments, the upper reservoir 140 may facilitate the water filter 200 to operably couple to the water level sensor 190 without requiring extension of electrical or electronic components through side walls 244, base wall 242, or plenum walls 247, 248 of the body 240. For instance, electrical or electronic components may extend through the top panel 243, such as through door 345, without requiring extension of electrical or electronic components through side walls 244, base wall 242, or plenum walls 247, 248 of the body 240.

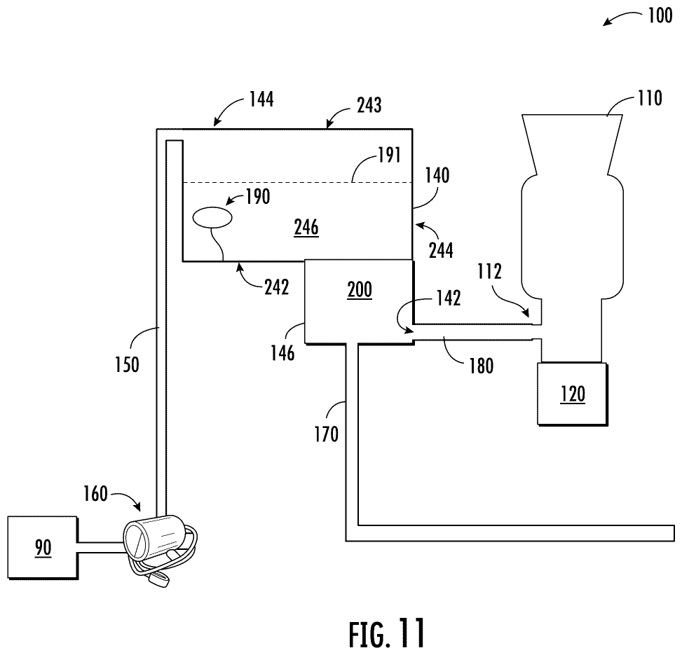

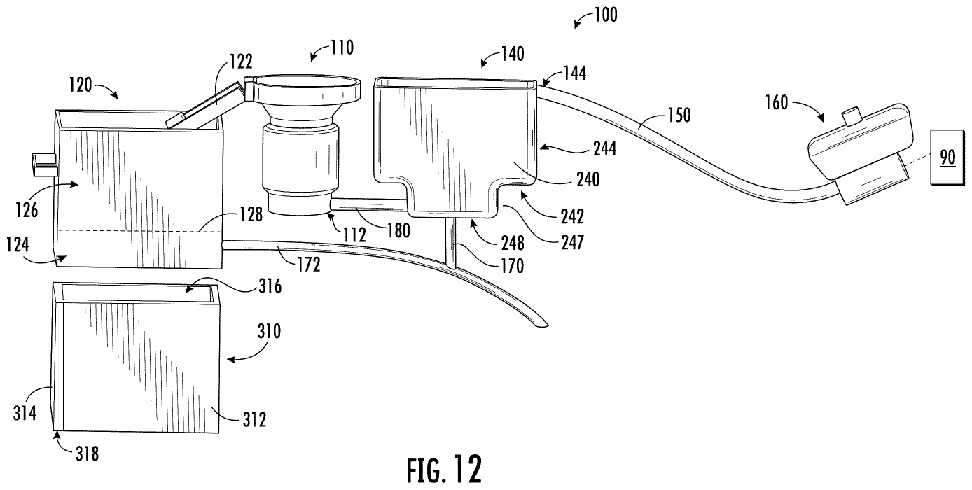

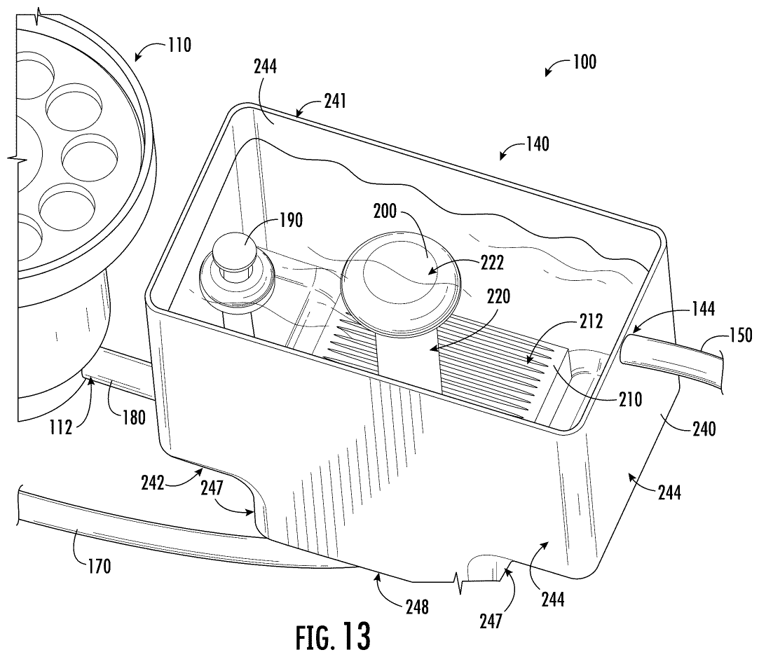

Referring to FIG. 11, a schematic embodiment of an ice maker appliance 100 is provided. FIG. 12 depicts a partially exploded view of components of the appliance 100 in accordance with the schematic embodiment of FIG. 11. FIG. 13 depicts an embodiment of the upper reservoir 140 and various components of the appliance 100 of FIG. 12. The embodiments of the appliance 100 depicted in FIGS. 11-13 include components such as described in regard to one or more embodiments of FIGS. 1-10. Referring to FIGS. 11-13, the water supply inlet opening 144 may be configured as a direct plumb-in connection to a main water supply 90, such as a main water source to a residence, office, or other edifice, such as may be coupled to a main water supply including a municipal water system or well-water system. In such embodiments, the upper reservoir supply conduit 150 fluidly couples to the water supply inlet opening 144 to provide water from the main water supply 90 to the upper reservoir 140. The flow control device 160 may form an articulatable valve configured to selectively permit flow of water through the upper reservoir supply conduit 150 to the upper reservoir 140. The flow control device 160 may include a manually articulatable valve, an electrically or electronically operable solenoid valve, or other appropriate type of manual or automatic selectively permissible flow device. In such embodiments, a second or lower reservoir may be obviated, as water for producing ice is provided from the main water supply 90 to the upper reservoir 140.

In various embodiments, such as described herein, the water level sensor 190 is positioned at the upper reservoir 140 and communicatively coupled to the flow control device 160 to selectively articulate and permit or urge flow of water to the upper reservoir 140. The water filter 200 positioned at the upper reservoir 140 is configured to filter water before entering the ice engine 110. The member 214 may form a plug at the drain opening 146, such that water from the upper reservoir 140 may drain through drain conduit 170 when the water filter 200 is removed from the upper reservoir 140. The drain conduit 170 may be fluidly coupled to a main drain system, such as fluidly coupled to a main sewage system or septic system.

Upper reservoir 140 may include embodiments of the articulatable top panel 243 such as described herein (e.g., at FIG. 10), such as may facilitate positioning and removal of the water filter 200 into the upper reservoir 140. Additionally, the articulatable top panel 243 may facilitate positioning of the sensing interface 222 at the water filter 200 in operable communication with the filter sensor 230, such as described herein.

Various embodiments of the direct plumb-in configuration may include openings positioned at heights or distances from a maximum water level height 191 in accordance with residential or commercial regulations or codes. For instance, the water supply inlet opening 144 may be positioned approximately one inch or more from the maximum water level height 191. Plumbing fittings at the openings may include any appropriate type of fitting as may be understood for direct plumb-in to a residential or commercial water source.

In such embodiments, a need for a supply conduit extending in fluid communication from a lower reservoir to an upper reservoir may be obviated, such as may further remove issues associated with undesired growth of mold, mildew, bacteria, viruses, scaling, or corrosion at a conduit configured to provide water from the lower reservoir to the upper reservoir. Additionally, or alternatively, removing a separate second or lower reservoir can facilitate forming the first or upper reservoir as an integral, unitary, monolithic body with fewer conduits between components, which may further facilitate housing the ice maker appliance within a cabinet having a smaller volume, or permit further space between heat-generating components (e.g., the heat exchanger for the ice engine 110) and volumes at which water is retained or flowed (e.g., conduits, reservoirs, plenums, etc.), which may further facilitate removing issues associated with undesired growth of mold, mildew, bacteria, viruses, scaling, or corrosion.

Referring to FIG. 12, in some embodiments, the ice storage vessel 120 may include a catchment volume 124 positioned below an ice storage volume 126. A perforated wall 128 permits flow of ice melt water from the ice storage volume 126 to the catchment volume 124. A drain conduit 172 extends in fluid communication from the catchment volume 124 to a drain. In some embodiments, the drain conduit 172 may fluidly connect (e.g., tee) to the drain conduit 170 extending in fluid communication from the upper reservoir 140 to a drain.

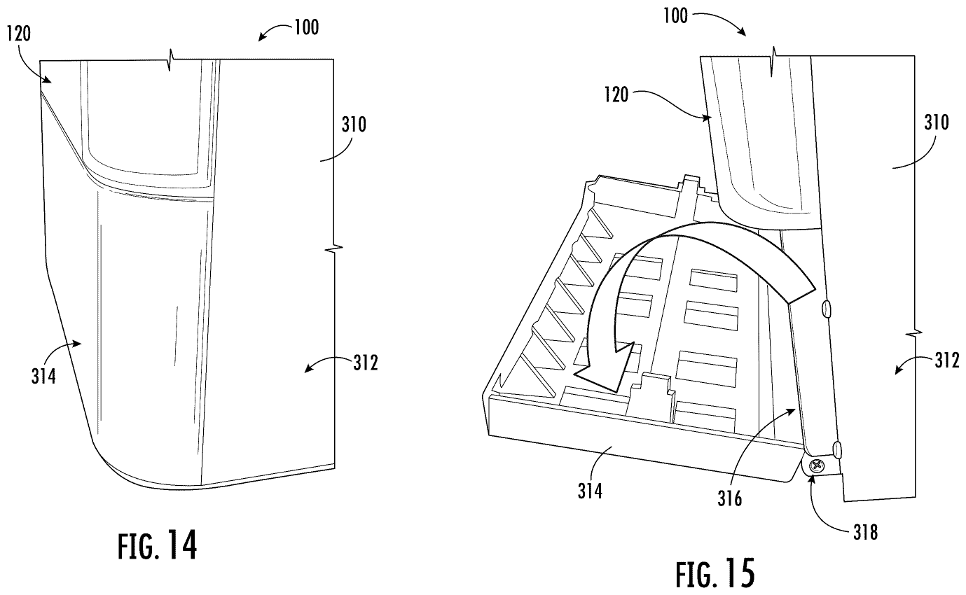

Referring still to FIG. 12, and to FIGS. 14-15, in various embodiments, the appliance 100 includes a housing 310 including a storage volume, such as may retain cleaning tools, cups, vessels, drinking utensils, or other components that may be complimentary or ancillary to operation or use of the appliance 100. The housing 310 includes a body 312 having a plurality of walls forming an internal volume 316 for storage. An articulatable door 314 provides selective access to the internal volume 316. For instance, FIG. 14 depicts the door 314 in a closed position, and FIG. 15 depicts the door 314 rotated (e.g., along a hinge 318) to an opening position. The hinge 318 may be connected to the body 312 of the housing 310, such as may facilitate coupling the door 314 in rotatable arrangement to the body 312.

In some embodiments, the articulatable door 314 and storage volume 316 are positioned beneath the ice storage vessel 120. For instance, the storage volume 316 may be positioned at a volume supplanting a lower reservoir volume. The door 314 may be positioned along a front face of the appliance 100, such as substantially co-planar to a front face or opening of the ice storage vessel 120.

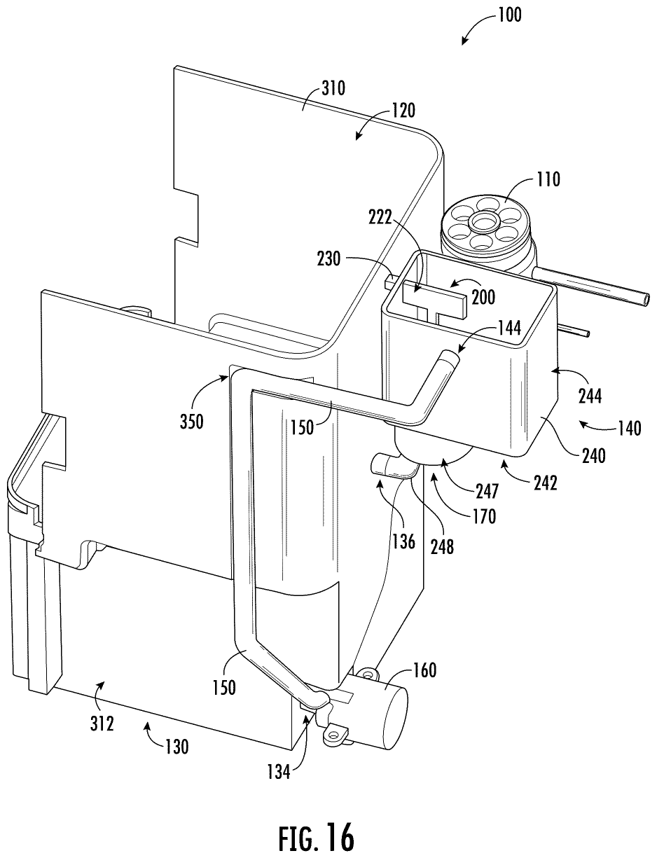

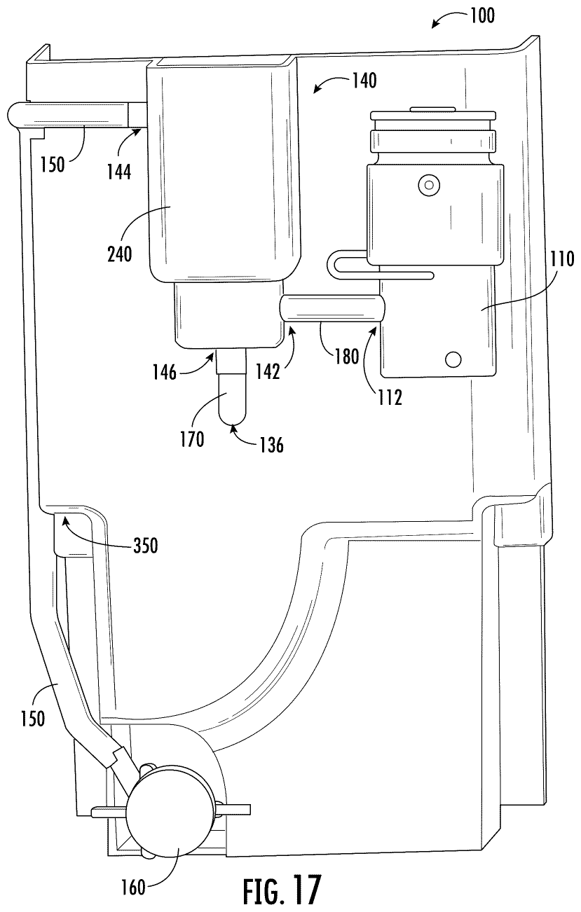

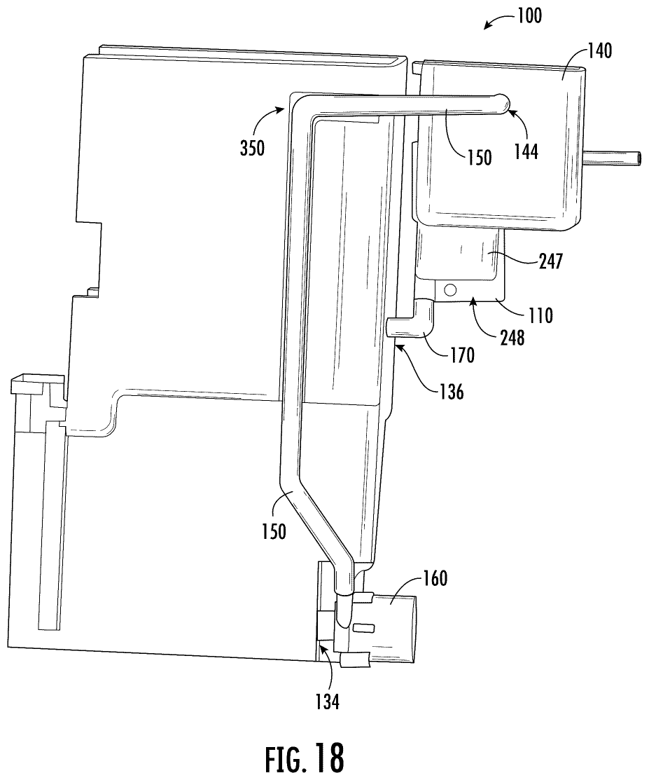

Referring now to FIGS. 16-18, views of an embodiment of components of an appliance 100 are provided. Views provided in FIGS. 16-18 exclude certain components for clarity, such as, but not limited to, the ice chute 122 extending from the ice engine 110 to the ice storage vessel 120, or various electronics and user interfaces. Embodiments of the appliance 100 depicted in FIGS. 16-18 may be configured substantially such as depicted and described in regard to FIG. 2B, FIG. 3, and FIGS. 7-9. In FIGS. 16-18, embodiments of the housing 310 include the lower reservoir 130 and the water supply outlet opening 134 and return opening 136. The ice storage vessel 120 may be positioned vertically above the lower reservoir 130. In various embodiments, the housing 310 may include the door and internal storage volume, such as described in regard to FIGS. 14-15.

In various embodiments, the housing 310 includes a groove or passageway 350 formed into one or more walls of the body 312. The passageway 350 may form an indentation into the body 312, such that a conduit (e.g., the upper reservoir supply conduit 150) is disposable into the body 312 at the passageway 350. The conduit is substantially housed in the passageway 350 (e.g., along at least 50% of a length of the conduit, or at least 60% of the conduit, or at least 75% of the conduit, or at least 90% of the conduit). The passageway 350 indented into the housing 310 embeds fluid tubes and conduits thereinto to avoid exposure to heat, such as heat from a heat exchanger or cooling system of the ice engine 110, heat generated from a controller, display, or other electronic device, or other heat-generating components. As such, the housing 310 may form a heat shield or insulating wall that may mitigate or eliminate exposure of the conduit (e.g., the upper reservoir supply conduit 150) to heat, such as may mitigate growth of mold, mildew, bacteria, viruses, scaling, or corrosion at the conduit.

In some embodiments, the appliance 100 receives the flow control device 160 directly onto the housing 310 at the water supply outlet opening 134, such as may eliminate a need for a tube or conduit extending from the water supply outlet opening 134 to the flow control device 160. The housing 310 may facilitate direct fluid coupling of the flow control device 160 to the receiving plenum 236 at the lower reservoir 130. Eliminating a need for a tube or conduit extending from a water supply opening to a flow control device may facilitate reducing a fluid flow path distance of the appliance, which may promote a pressure drop from end to end of a conduit that can facilitate various types of flow control device configurations, such as various configurations of pump, impeller, nozzle, etc., which may further facilitate a flow control device configuration permitting drainage of the upper reservoir supply conduit 150 during deactivation, such as may mitigate growth of mold, mildew, bacteria, viruses, scaling, or corrosion at the conduit.

Embodiments of the housing 310 may include an integral, unitary, monolithic structure including the ice storage vessel 120, the lower reservoir 130, and openings such as described herein. The monolithic housing 310 may facilitate positioning the ice maker appliance within a cabinet having a smaller volume, or permit further space between heat-generating components (e.g., the heat exchanger for the ice engine 110) and volumes at which water is retained or flowed (e.g., conduits, reservoirs, plenums, etc.), which may further facilitate removing issues associated with undesired growth of mold, mildew, bacteria, viruses, scaling, or corrosion.

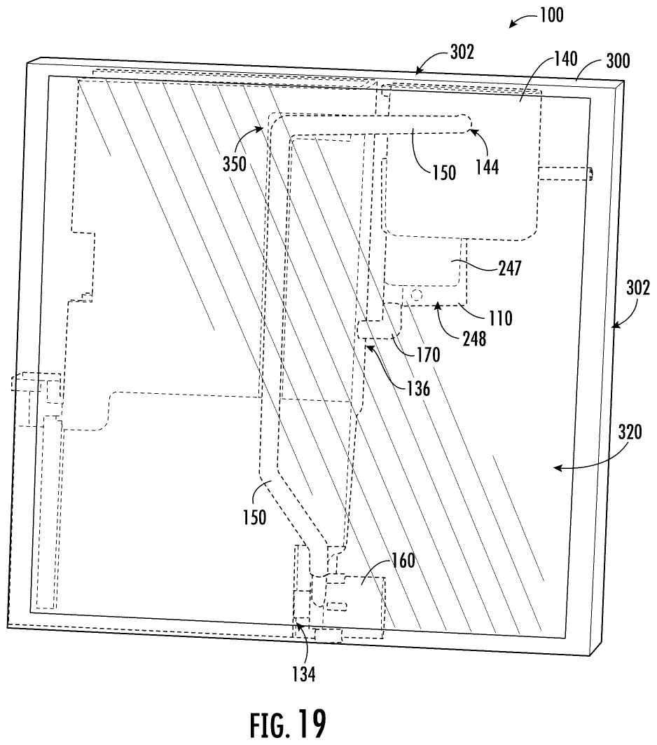

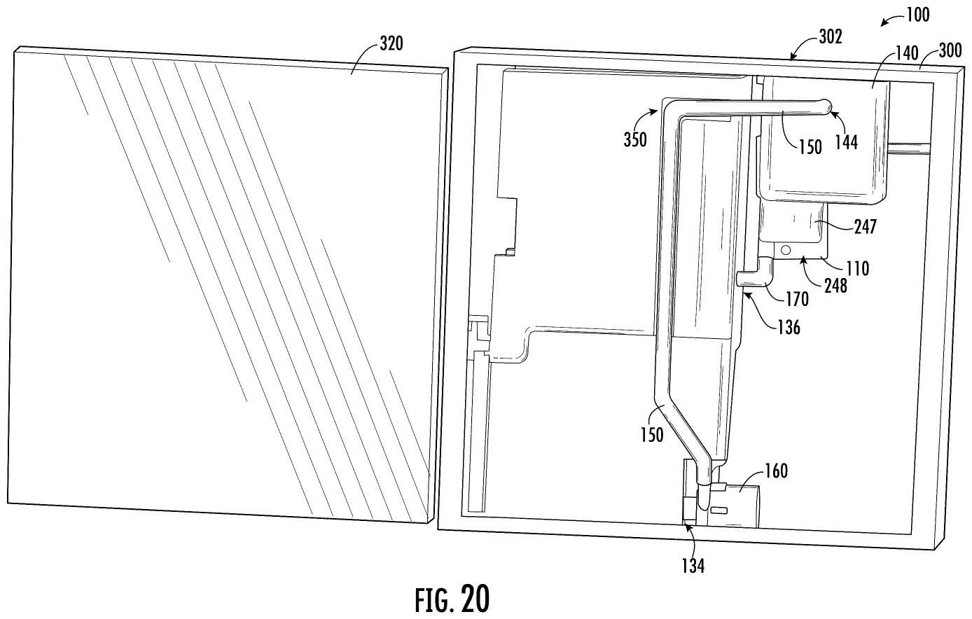

Referring now to FIGS. 19-20, a side view of an embodiment of the appliance 100 is provided. The embodiment depicted in FIGS. 19-20 is configured substantially as depicted and described in regard to FIG. 18. FIGS. 19-20 further depict a cabinet 300 surrounding components of the ice maker appliance 100 such as described in regard to various embodiments herein. The cabinet 300 includes a plurality of outer walls 302 forming an interior or internal volume 304 at which various components of the appliance 100 are at least partially positioned, such as, but not limited to, the ice engine 110, the ice storage vessel 120, the reservoirs 130, 140, conduits 150, 170, 180, and electrical, electronic, sensor, display, and user interface apparatuses. The plurality of walls 302 include a door or articulatable panel 320 extending along a side of the appliance corresponding substantially to the housing 310 and passageway 350 at the body 312. The articulatable panel 320 is configured to slide, rotate, or otherwise displace to provide selective user access to the internal volume 304 within the cabinet 300. The articulatable panel 320 extending alongside the passageway 350 may permit a user to access one or more conduits (e.g., upper reservoir supply conduit 150) for cleaning, replacement, repair, or servicing.

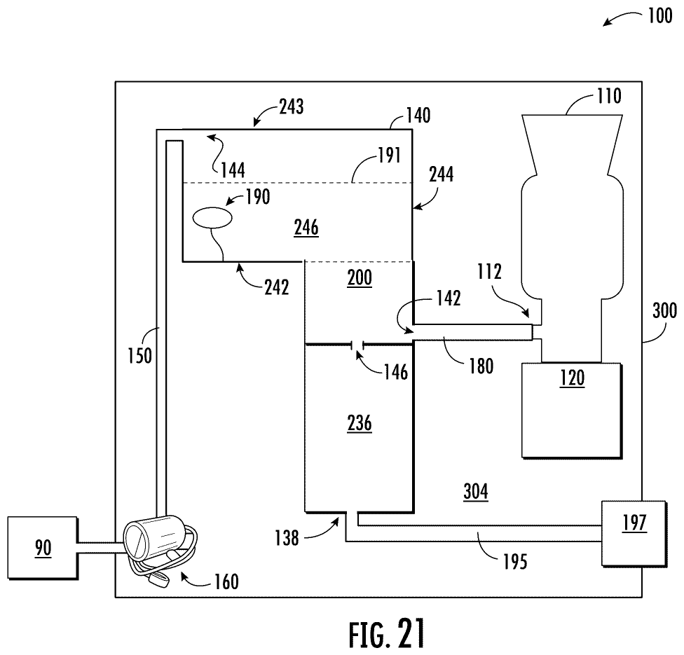

Referring now to FIG. 21, a schematic embodiment of the appliance 100 is provided. The appliance 100 may be configured substantially as described in regard to various embodiments depicted and described herein, such as FIG. 11. The upper reservoir 140 may include side walls 244 extending vertically below the water filter 200 to form a lower or second receiving plenum 236. The second receiving plenum 236 is positioned fluidly downstream of the water filter 200 and the first receiving plenum 246. In various embodiments, upper reservoir 140 includes walls 242, 244, 247, 248 forming an integral, unitary, monolithic component including the first receiving plenum 246, the water filter plenum 245, and the second receiving plenum 236.

The reservoir 140 includes an egress opening 138 in fluid communication with the second receiving plenum 236 at which egress conduit 195 fluidly couples. Conduit 195 may be fluidly coupled to fitting 197 forming a release valve or spigot configured to permit selective user flow of water from the second receiving plenum 236. Valve or fitting 197 may be mounted to the cabinet 300, such as may permit selective discharge of water from the reservoir (e.g., fresh water supply to the user). The second receiving plenum 236 may form a filtered water tank receiving filtered water from the water filter 200. As such, a portion of water filtered from the water filter 200 is directed to the ice engine 110 and a portion of water filtered from the water filter 200 is directed to the second receiving plenum 236 for user consumption.

In such embodiments, a need for a supply conduit extending in fluid communication from a lower reservoir to an upper reservoir may be obviated, such as may further remove issues associated with undesired growth of mold, mildew, bacteria, viruses, scaling, or corrosion at a conduit configured to provide water from the lower reservoir to the upper reservoir. Additionally, or alternatively, removing a separate second or lower reservoir can facilitate forming the first or upper reservoir as an integral, unitary, monolithic body with fewer conduits between components, which may further facilitate housing the ice maker appliance within a cabinet having a smaller volume, or permit further space between heat-generating components (e.g., the heat exchanger for the ice engine 110) and volumes at which water is retained or flowed (e.g., conduits, reservoirs, plenums, etc.), which may further facilitate removing issues associated with undesired growth of mold, mildew, bacteria, viruses, scaling, or corrosion.

Further aspects of the subject matter are provided in one or more of the following clauses:

1. An ice maker appliance, the ice maker appliance including an ice engine including a water supply opening; a flow control device; a lower reservoir including a supply outlet opening and a return opening; an upper reservoir including a supply inlet opening, an ice engine supply opening, and a drain opening; an upper reservoir supply conduit fluidly coupling the lower reservoir to the upper reservoir, wherein the upper reservoir supply conduit fluidly couples from the supply outlet opening to the supply inlet opening, and wherein the flow control device is configured to selectively feed water through the upper reservoir supply conduit from the lower reservoir to the upper reservoir; a drain conduit fluidly coupling the upper reservoir to the lower reservoir, wherein the drain conduit fluidly couples from the drain opening to the return opening, wherein the drain conduit is configured to gravitationally feed water from the drain opening at the upper reservoir to the return opening at the lower reservoir; and a water supply conduit fluidly coupling the upper reservoir to the ice engine, wherein the water supply conduit fluidly couples from the ice engine supply opening to the water supply opening.

2. The ice maker appliance of any one or more clauses herein, wherein the drain conduit includes a substantially constant flow area from the drain opening at the upper reservoir to the return opening at the lower reservoir.

3. The ice maker appliance of any one or more clauses herein, wherein the drain conduit extending from the drain opening at the upper reservoir to the return opening at the lower reservoir is free of a fluid flow control device configured to feed water from the drain opening to the return opening greater than a flow rate corresponding to gravitationally feeding water from the drain opening to the return opening.

4. The ice maker appliance of any one or more clauses herein, wherein the flow control device is configured to permit flow from the upper reservoir to the lower reservoir when the flow control device is deactivated.

5. The ice maker appliance of any one or more clauses herein, wherein the flow control device includes a centrifugal flow control device.

6. The ice maker appliance of any one or more clauses herein, the ice maker appliance including a water level sensor configured to determine a water height at the upper reservoir.

7. The ice maker appliance of any one or more clauses herein, wherein the supply inlet opening is positioned at the upper reservoir greater than a maximum water level height.

8. The ice maker appliance of any one or more clauses herein, wherein the water level sensor is operably coupled to the flow control device, and wherein the flow control device is configured to activate to supply water from the lower reservoir to the upper reservoir when the water level sensor determines a water height at the upper reservoir at or less than a minimum water level height.

9. The ice maker appliance of any one or more clauses herein, wherein the flow control device is configured to deactivate to discontinue supplying water from the lower reservoir to the upper reservoir when the water level sensor determines the water height at the upper reservoir at or greater than a maximum water level height.

10. The ice maker appliance of any one or more clauses herein, wherein a flow area at the drain conduit is less than a flow area at the upper reservoir supply conduit.

11. The ice maker appliance of any one or more clauses herein, the ice maker appliance including a water filter positioned at the upper reservoir, the water filter fluidly upstream of the water supply conduit and the ice engine.

12. The ice maker appliance of any one or more clauses herein, wherein the ice maker appliance is free of a water filter positioned at the lower reservoir.

13. The ice maker appliance of any one or more clauses herein, wherein the ice maker appliance is free of a water filter positioned fluidly upstream of the flow control device to the lower reservoir.

14. The ice maker appliance of any one or more clauses herein, wherein the water filter positioned at the upper reservoir is positioned fluidly upstream of the ice engine supply opening and the drain opening, wherein water at the upper reservoir passes through the water filter to flow to the ice engine supply opening or the drain opening.

15. The ice maker appliance of any one or more clauses herein, wherein the return opening at the lower reservoir is positioned at a greater height than the supply outlet opening at the lower reservoir.

16. The ice maker appliance of any one or more clauses herein, wherein the upper reservoir supply conduit and the supply outlet opening at the lower reservoir are configured to provide a greater flow rate to the lower reservoir when the flow control device is deactivated than gravitational feed of water from the drain opening at the upper reservoir to the return opening at the lower reservoir.

17. The ice maker appliance of any one or more clauses herein, wherein the flow control device is received directly onto the lower reservoir at the supply outlet opening.

18. The ice maker appliance of any one or more clauses herein, the ice maker appliance including a lower reservoir egress conduit including a quick-release fitting.

19. The ice maker appliance of any one or more clauses herein, the ice maker appliance including a second reservoir positioned adjacent to the lower reservoir, wherein the lower reservoir egress conduit fluidly couples the lower reservoir to the second reservoir.

20. The ice maker appliance of any one or more clauses herein, wherein the ice maker appliance includes a nugget ice maker appliance.

21. An ice maker appliance, the ice maker appliance including an ice engine including a water supply opening; a flow control device; a lower reservoir including a supply outlet opening and a return opening; an upper reservoir including a supply inlet opening, an ice engine supply opening, a drain opening, and a water filter positioned at the upper reservoir; a water supply conduit fluidly coupling the upper reservoir to the ice engine, wherein the water supply conduit fluidly couples from the ice engine supply opening to the water supply opening, wherein the water filter is positioned fluidly upstream of the drain opening, the ice engine supply opening, or both; and an upper reservoir supply conduit fluidly coupling the lower reservoir to the upper reservoir, wherein the upper reservoir supply conduit fluidly couples from the supply outlet opening to the supply inlet opening, and wherein the flow control device is configured to selectively feed water through the upper reservoir supply conduit from the lower reservoir to the upper reservoir.

22. The ice maker appliance of any one or more clauses herein, wherein the ice maker appliance is free of a filter positioned at the lower reservoir.

23. The ice maker appliance of any one or more clauses herein, wherein the ice maker appliance is free of a filter positioned fluidly upstream of the flow control device to the lower reservoir.

24. The ice maker appliance of any one or more clauses herein, wherein the water filter positioned at the upper reservoir is positioned fluidly upstream of the ice engine supply opening and a drain opening at the upper reservoir, and wherein water at the upper reservoir passes through the water filter to flow to the ice engine supply opening or the drain opening.

25. The ice maker appliance of any one or more clauses herein, the water filter including a filter body at which a filtration medium is positioned; and a hanger extending from the filter body, the hanger configured to extend around an upper lip of the upper reservoir.

26. The ice maker appliance of any one or more clauses herein, the ice maker appliance including a filter sensor positioned to determine a presence of the water filter at the upper reservoir.

27. The ice maker appliance of any one or more clauses herein, wherein the filter sensor is configured to determine contact of the hanger to the filter sensor.

28. The ice maker appliance of any one or more clauses herein, the ice maker appliance including a drain conduit fluidly coupling the upper reservoir to the lower reservoir, wherein the drain conduit fluidly couples from a drain opening at the upper reservoir to a return opening at the lower reservoir.

29. The ice maker appliance of any one or more clauses herein, wherein the water filter includes a member extending from the filter body into the drain opening at the upper reservoir.

30. The ice maker appliance of any one or more clauses herein, wherein the member extending from the filter body corresponds in geometry to the drain opening at the upper reservoir to prohibit flow from the upper reservoir into the drain conduit.

31. The ice maker appliance of any one or more clauses herein, wherein the member extending from the filter body is configured to permit a metered flow rate of water from the upper reservoir through the drain conduit.

32. The ice maker appliance of any one or more clauses herein, wherein a flow area at the drain conduit is less than a flow area at the upper reservoir supply conduit.

33. The ice maker appliance of any one or more clauses herein, wherein the upper reservoir includes an articulatable door permitting selective access into the upper reservoir.

34. The ice maker appliance of any one or more clauses herein, the water filter including a filter body at which a filtration medium is positioned; and a hanger extending from the filter body, the hanger configured to extend around an upper lip of the upper reservoir at which the articulatable door contacts in a closed position.

35. The ice maker appliance of any one or more clauses herein, the ice maker appliance including a filter sensor positioned at the upper reservoir to determine a presence of the water filter at the upper reservoir.

36. The ice maker appliance of any one or more clauses herein, wherein the filter sensor is positioned at the articulatable door to determine contact of the hanger to the filter sensor.

37. The ice maker appliance of any one or more clauses herein, wherein a drain conduit fluidly couples the upper reservoir to the lower reservoir, and wherein the drain conduit fluidly couples from a drain opening at the upper reservoir to a return opening at the lower reservoir, and wherein the drain conduit extending from the drain opening at the upper reservoir to the return opening at the lower reservoir is free of a fluid flow control device configured to feed water from the drain opening to the return opening greater than a flow rate corresponding to gravitationally feeding water from the drain opening to the return opening.

38. The ice maker appliance of any one or more clauses herein, wherein the flow control device is configured to permit flow from the upper reservoir to the lower reservoir when the flow control device is deactivated.

39. The ice maker appliance of any one or more clauses herein, wherein the flow control device includes a centrifugal flow control device.

40. The ice maker appliance of any one or more clauses herein, the ice maker appliance including a water level sensor configured to determine a water height at the upper reservoir, wherein the water level sensor is operably coupled to the flow control device, and wherein the flow control device is configured to activate to supply water from the lower reservoir to the upper reservoir when the water level sensor determines a water height at the upper reservoir at or less than a minimum water level height, and wherein the flow control device is configured to deactivate to discontinue supplying water from the lower reservoir to the upper reservoir when the water level sensor determines the water height at the upper reservoir at or greater than a maximum water level height.

41. An ice maker appliance, the ice maker appliance including an ice engine including a water supply opening; a flow control device; a lower reservoir including a supply outlet opening and a return opening; an upper reservoir including a supply inlet opening, an ice engine supply opening, and a drain opening, the upper reservoir includes a passage at which a water filter is disposable in fluid arrangement between a receiving plenum of the upper reservoir and the drain opening, the upper reservoir including a flow separation wall extending from the drain opening and into the receiving plenum, wherein the flow separation wall forms a bypass passage extending from a bypass inlet opening to the drain opening, wherein the bypass passage fluidly bypasses the water filter from the receiving plenum to the drain opening; a drain conduit fluidly coupling the upper reservoir to the lower reservoir, wherein the drain conduit fluidly couples from the drain opening to the return opening; a water supply conduit fluidly coupling the upper reservoir to the ice engine, wherein the water supply conduit fluidly couples from the ice engine supply opening to the water supply opening, wherein the water filter is positioned fluidly upstream of the water supply conduit and the ice engine; and an upper reservoir supply conduit fluidly coupling the lower reservoir to the upper reservoir, wherein the upper reservoir supply conduit fluidly couples from supply outlet opening to the supply inlet opening, wherein the flow control device is configured to selectively feed water through the upper reservoir supply conduit from the lower reservoir to the upper reservoir.

42. The ice maker appliance of any one or more clauses herein, wherein the bypass inlet opening is positioned at a height at the receiving plenum greater than a filter body at which a filtration medium is positioned at the water filter, and wherein the bypass inlet opening is positioned at the height at the receiving plenum less than the supply inlet opening.

43. The ice maker appliance of any one or more clauses herein, wherein the flow separation wall and an inner wall of the upper reservoir form a water filter plenum at which the water filter is disposed.

44. The ice maker appliance of any one or more clauses herein, wherein the drain conduit extending from the drain opening at the upper reservoir to the return opening at the lower reservoir is free of a fluid flow control device configured to feed water from the drain opening to the return opening greater than a flow rate corresponding to gravitationally feeding water from the drain opening to the return opening.

45. The ice maker appliance of any one or more clauses herein, wherein the upper reservoir includes a body including a side wall and a base wall, wherein the supply inlet opening, the drain opening, and the ice engine supply opening are formed through the body, the body forming the receiving plenum at which water is received from the supply inlet opening.

46. The ice maker appliance of any one or more clauses herein, wherein the body of the upper reservoir is free of electrical or electronic components extending through the body into the receiving plenum.

47. The ice maker appliance of any one or more clauses herein, wherein the upper reservoir includes an articulatable top panel permitting selective access to the receiving plenum, wherein the top panel couples to the body of the upper reservoir.

48. The ice maker appliance of any one or more clauses herein, the water filter including a filter body at which a filtration medium is positioned; and a hanger extending from the filter body, the hanger configured to extend around an upper lip of the upper reservoir at which the articulatable top panel contacts the body in a closed position.

49. The ice maker appliance of any one or more clauses herein, the ice maker appliance including a filter sensor positioned at an outer wall of the upper reservoir, the filter sensor configured to determine a presence of the water filter at the upper reservoir.

50. The ice maker appliance of any one or more clauses herein, the ice maker appliance including a filter sensor positioned at the top panel of the upper reservoir, wherein the filter sensor is positioned at the top panel to determine a presence of the water filter at the upper reservoir.

51. The ice maker appliance of any one or more clauses herein, wherein the drain conduit extending from the drain opening at the upper reservoir to the return opening at the lower reservoir is free of a fluid flow control device configured to feed water from the drain opening to the return opening greater than a flow rate corresponding to gravitationally feeding water from the drain opening to the return opening.

52. The ice maker appliance of any one or more clauses herein, wherein the drain opening at the upper reservoir includes a first drain opening fluidly downstream of the water filter; and a second drain opening fluidly downstream of the bypass passage.

53. The ice maker appliance of any one or more clauses herein, wherein the first drain opening is configured to feed water from the first drain opening to the drain conduit at a first flow rate less than a second flow rate corresponding to the second drain opening configured to feed water from the second drain opening to the drain conduit.

54. The ice maker appliance of any one or more clauses herein, wherein the water filter includes a member extending from a filter body into the first drain opening at the upper reservoir, or additionally, wherein the member extending from the filter body is configured to permit a first flow rate of water from the upper reservoir to the drain conduit, the first flow rate less than a second flow rate corresponding to the second drain opening configured to feed water from the second drain opening to the drain conduit.

55. The ice maker appliance of any one or more clauses herein, wherein the ice maker appliance is free of a filter positioned at the lower reservoir or fluidly upstream of the flow control device to the lower reservoir.

56. The ice maker appliance of any one or more clauses herein, wherein the flow control device is configured to permit flow from the upper reservoir to the lower reservoir when the flow control device is deactivated.

57. The ice maker appliance of any one or more clauses herein, wherein the water filter positioned at the upper reservoir is positioned fluidly upstream of the ice engine supply opening and the drain opening at the upper reservoir, and wherein water at the receiving plenum passes through the water filter to flow to the ice engine supply opening and the drain opening.

58. The ice maker appliance of any one or more clauses herein, wherein the flow separation wall includes a tube extending in fluid communication from the receiving plenum to the drain opening.

59. The ice maker appliance of any one or more clauses herein, wherein the flow control device is configured to operate to flow water to the upper reservoir when, or before, the ice engine operates to produce ice.

60. The ice maker appliance of any one or more clauses herein, wherein the flow control device is configured to flow water from the lower reservoir to the upper reservoir, and wherein the flow control device is communicatively coupled to a water level sensor at the lower reservoir to selectively operate the flow control device to remove water from the lower reservoir to the upper reservoir, and wherein the drain conduit fluidly couples from the drain opening at the upper reservoir to the return opening at the lower reservoir to permit flow of water from the upper reservoir to the lower reservoir.

61. An ice maker appliance, the ice maker appliance including an ice engine including a water supply opening; a flow control device; a lower reservoir including a supply outlet opening; an upper reservoir including a body, the body including a side wall and a base wall, wherein a supply inlet opening, and an ice engine supply opening are formed through the body, and wherein the body forms a receiving plenum at which water is received from the supply inlet opening, and wherein the upper reservoir includes an articulatable top panel permitting selective access to the receiving plenum, wherein the top panel couples to the body; a water supply conduit fluidly coupling the upper reservoir to the ice engine, wherein the water supply conduit fluidly couples from the ice engine supply opening to the water supply opening, wherein the water filter is positioned fluidly upstream of the water supply conduit and the ice engine; and an upper reservoir supply conduit fluidly coupling the lower reservoir to the upper reservoir, wherein the upper reservoir supply conduit fluidly couples from the supply outlet opening to the supply inlet opening, and wherein the flow control device is configured to selectively feed water through the upper reservoir supply conduit from the lower reservoir to the upper reservoir.

62. The ice maker appliance of any one or more clauses herein, wherein a hinge couples the top panel to the body of the upper reservoir.

63. The ice maker appliance of any one or more clauses herein, wherein the top panel is configured to couple to an upper lip of the body as a snap fit.

64. The ice maker appliance of any one or more clauses herein, wherein the top panel is configured to slide relative to the body to permit selective access to the receiving plenum.

65. The ice maker appliance of any one or more clauses herein, the ice maker appliance including a water level sensor configured to determine a water height at the upper reservoir.

66. The ice maker appliance of any one or more clauses herein, wherein the water level sensor includes an electrical communication lead extending through the body into the receiving plenum.

67. The ice maker appliance of any one or more clauses herein, wherein the electrical communication lead extends through the side wall of the body into the receiving plenum.

68. The ice maker appliance of any one or more clauses herein, wherein the electrical communication lead extends through the base wall of the body into the receiving plenum.

69. The ice maker appliance of any one or more clauses herein, the ice maker appliance including a water filter disposable in fluid arrangement between the receiving plenum and the ice engine supply opening at the upper reservoir.

70. The ice maker appliance of any one or more clauses herein, the water filter including a filter body at which a filtration medium is positioned; and a hanger extending from the filter body, the hanger configured to extend around an upper lip of the body at which the top panel contacts the body in a closed position.

71. The ice maker appliance of any one or more clauses herein, the ice maker appliance including a filter sensor positioned at the upper reservoir to determine a presence of the water filter at the upper reservoir.

72. The ice maker appliance of any one or more clauses herein, wherein the filter sensor is positioned at the top panel to determine contact of the hanger to the filter sensor.

73. The ice maker appliance of any one or more clauses herein, wherein the filter sensor is positioned at an outer wall of the body, the filter sensor configured to determine a presence of the hanger of the water filter extending over the upper lip of the body.

74. The ice maker appliance of any one or more clauses herein, wherein the water filter positioned at the upper reservoir is positioned fluidly upstream of the ice engine supply opening and a drain opening at the upper reservoir, and wherein water at the upper reservoir passes through the water filter to flow to the ice engine supply opening and the drain opening.

75. The ice maker appliance of any one or more clauses herein, the ice maker appliance including a drain conduit fluidly coupling the upper reservoir to the lower reservoir, wherein the drain conduit fluidly couples from the drain opening at the upper reservoir to a return opening at the lower reservoir.

76. The ice maker appliance of any one or more clauses herein, wherein the water filter includes a member extending from the filter body into the drain opening at the upper reservoir.

77. The ice maker appliance of any one or more clauses herein, wherein the member extending from the filter body corresponds in geometry to the drain opening at the upper reservoir to prohibit flow from the upper reservoir into the drain conduit.

78. The ice maker appliance of any one or more clauses herein, wherein the member extending from the filter body is configured to permit a metered flow rate of water from the upper reservoir through the drain conduit.

79. The ice maker appliance of any one or more clauses herein, wherein a flow area at the drain conduit is less than a flow area at the upper reservoir supply conduit.

80. The ice maker appliance of any one or more clauses herein, the ice maker appliance including a water level sensor configured to determine a water height at the upper reservoir, wherein the water level sensor is operably coupled to the flow control device, and wherein the flow control device is configured to activate to supply water from the lower reservoir to the upper reservoir when the water level sensor determines a water height at the upper reservoir at or less than a minimum water level height, and wherein the flow control device is configured to deactivate to discontinue supplying water from the lower reservoir to the upper reservoir when the water level sensor determines the water height at the upper reservoir at or greater than a maximum water level height.

81. An ice maker appliance, the ice maker appliance including an ice engine including a water supply opening; a reservoir including a body, the body including a side wall and a base wall, wherein a supply inlet opening, and an ice engine supply opening are formed through the body, and wherein the body forms a receiving plenum at which water is received from the supply inlet opening; a water level sensor configured to determine a water height at the reservoir; a water supply conduit fluidly coupling the reservoir to the ice engine, wherein the water supply conduit fluidly couples from the ice engine supply opening to the water supply opening, wherein the water filter is positioned fluidly upstream of the water supply conduit and the ice engine; a water filter positioned at the reservoir, the water filter positioned fluidly upstream of a drain opening, the ice engine supply opening, or both; and a reservoir supply conduit fluidly coupling the reservoir to a main water supply and a flow control device, wherein the flow control device is operably coupled to the water level sensor to selectively permit flow of water through the reservoir supply conduit to the reservoir based on the water height at the reservoir.

82. The ice maker appliance of any one or more clauses herein, the ice maker appliance including a valve configured to selectively discharge water from the reservoir, wherein a drain conduit fluidly couples the valve to the drain opening at the reservoir.

83. The ice maker appliance of any one or more clauses herein, wherein the water filter is positioned fluidly upstream of the drain opening.

84. The ice maker appliance of any one or more clauses herein, wherein the flow control device includes a fill valve extending into the receiving plenum of the reservoir.

85. The ice maker appliance of any one or more clauses herein, wherein the ice maker appliance is free of a second reservoir configured to feed water from the second reservoir to the reservoir.

86. The ice maker appliance of any one or more clauses herein, including a cabinet forming an interior, wherein the reservoir is at least partially housed at the interior of the cabinet.

87. The ice maker appliance of any one or more clauses herein, wherein a valve configured to selectively discharge water from the reservoir is mounted to the cabinet.

88. The ice maker appliance of any one or more clauses herein, the cabinet including a plurality of walls forming the interior, wherein at least one of the plurality of walls includes an articulatable door.

89. The ice maker appliance of any one or more clauses herein, wherein the articulatable door provides selective access to a storage volume extending from the door to a portion of the interior of the cabinet.

90. The ice maker appliance of any one or more clauses herein, wherein the articulatable door is positioned beneath an ice storage vessel.

91. The ice maker appliance of any one or more clauses herein, wherein the articulatable door is positioned at a front face of the plurality of walls of the cabinet.

92. The ice maker appliance of any one or more clauses herein, wherein the valve configured to selectively discharge water from the reservoir is mounted to a side wall of the plurality of walls of the cabinet.

93. The ice maker appliance of any one or more clauses herein, wherein the supply inlet opening is positioned at the reservoir vertically above a maximum water level height of the water level sensor.

94. The ice maker appliance of any one or more clauses herein, wherein the flow control device includes a flow control device.

95. The ice maker appliance of any one or more clauses herein, wherein the water filter is positioned fluidly between the receiving plenum and a filtered water plenum.

96. The ice maker appliance of any one or more clauses herein, wherein the reservoir includes a drain opening at the filtered water plenum.

97. The ice maker appliance of any one or more clauses herein, the ice maker appliance including a valve configured to selectively discharge water from the reservoir, wherein a drain conduit fluidly couples the valve to the drain opening at the filtered water plenum of the reservoir.

98. The ice maker appliance of any one or more clauses herein, the water filter including a filter body at which a filtration medium is positioned; and a hanger extending from the filter body, the hanger configured to extend around an upper lip of the body at which a top panel of the reservoir contacts the body in a closed position.

99. The ice maker appliance of any one or more clauses herein, the ice maker appliance including a filter sensor positioned at the reservoir to determine a presence of the water filter at the reservoir.

100. The ice maker appliance of any one or more clauses herein, wherein the filter sensor is positioned at the top panel to determine contact of the hanger to the filter sensor.

101. An ice maker appliance, the ice maker appliance including a cabinet including a plurality of walls forming an interior, wherein at least one of the plurality of walls includes an articulatable door; an ice engine including a water supply opening; a reservoir including a body, the body including a side wall and a base wall, wherein a supply inlet opening and an ice engine supply opening are formed through the body, and wherein the body forms a receiving plenum at which water is received from the supply inlet opening, and wherein the reservoir is at least partially housed at the interior of the cabinet; a water level sensor configured to determine a water height at the reservoir; a water supply conduit fluidly coupling the reservoir to the ice engine, wherein the water supply conduit fluidly couples from the ice engine supply opening to the water supply opening, wherein the water filter is positioned fluidly upstream of the water supply conduit and the ice engine; a water filter positioned at the reservoir, wherein the water filter is positioned fluidly upstream of the water supply conduit and the ice engine supply opening; and a reservoir supply conduit fluidly coupling the reservoir to a main water supply and a flow control device, wherein the flow control device is operably coupled to the water level sensor to selectively permit flow of water through the reservoir supply conduit to the reservoir based on the water height at the reservoir.

102. The ice maker appliance of any one or more clauses herein, wherein the articulatable door provides selective access to a storage volume extending from the door to a portion of the interior of the cabinet.

103. The ice maker appliance of any one or more clauses herein, the ice maker appliance including an ice storage vessel configured to receive ice produced from the ice engine.

104. The ice maker appliance of any one or more clauses herein, wherein the articulatable door is positioned beneath the ice storage vessel.

105. The ice maker appliance of any one or more clauses herein, wherein the articulatable door is positioned at a front face of the plurality of walls of the cabinet.

106. The ice maker appliance of any one or more clauses herein, the ice maker appliance including a valve configured to selectively discharge water from the reservoir, wherein a drain conduit fluidly couples the valve to a drain opening at the reservoir.

107. The ice maker appliance of any one or more clauses herein, wherein the valve configured to selectively discharge water from the reservoir is mounted to a side wall of the plurality of walls of the cabinet.

108. The ice maker appliance of any one or more clauses herein, wherein the water filter is positioned fluidly between the receiving plenum and a filtered water plenum.

109. The ice maker appliance of any one or more clauses herein, wherein the reservoir includes a drain opening at the filtered water plenum.

110. The ice maker appliance of any one or more clauses herein, the ice maker appliance including a valve configured to selectively discharge water from the reservoir, wherein a drain conduit fluidly couples the valve to the drain opening at the filtered water plenum of the reservoir.

111. The ice maker appliance of any one or more clauses herein, wherein the reservoir includes a passageway formed into a housing at which the reservoir is positioned, wherein the passageway receives the water supply conduit indented into the housing.

112. The ice maker appliance of any one or more clauses herein, wherein the cabinet includes an articulatable panel extending along a side of the cabinet corresponding to the passageway formed into the housing.

113. The ice maker appliance of any one or more clauses herein, wherein the articulatable panel is detachable from the cabinet to provide access to the interior of the cabinet.

114. An ice maker appliance, the ice maker appliance including a cabinet including a plurality of walls forming an interior, wherein at least one of the plurality of walls includes an articulatable door; an ice engine including a water supply opening; a reservoir including a body, the body including a side wall and a base wall, wherein a supply inlet opening, a drain opening, and an ice engine supply opening are formed through the body, and wherein the body forms an upper receiving plenum at which water is received from the supply inlet opening, and wherein the reservoir is at least partially housed at the interior of the cabinet; a water level sensor configured to determine a water height at the reservoir; a water supply conduit fluidly coupling the reservoir to the ice engine, wherein the water supply conduit fluidly couples from the ice engine supply opening to the water supply opening, wherein the water filter is positioned fluidly upstream of the water supply conduit and the ice engine; a water filter positioned at the reservoir, the water filter positioned fluidly between the upper receiving plenum and the drain opening, and wherein the drain opening is fluidly coupled to a lower receiving plenum at which filtered water is received from the drain opening; and a reservoir supply conduit fluidly coupling the reservoir to a main water supply and a flow control device, wherein the flow control device is operably coupled to the water level sensor to selectively permit flow of water through the reservoir supply conduit to the reservoir based on the water height at the reservoir.

115. The ice maker appliance of any one or more clauses herein, wherein the articulatable door provides selective access to a storage volume extending from the door to a portion of the interior of the cabinet.

116. The ice maker appliance of any one or more clauses herein, the ice maker appliance including an ice storage vessel configured to receive ice produced from the ice engine, wherein the articulatable door is positioned beneath the ice storage vessel.

117. The ice maker appliance of any one or more clauses herein, wherein the articulatable door is positioned at a front face of the plurality of walls of the cabinet.

118. The ice maker appliance of any one or more clauses herein, wherein the body of the reservoir forms an integral, unitary, monolithic component including the upper receiving plenum, a water filter plenum at which the water filter is positioned, and the lower receiving plenum.

119. The ice maker appliance of any one or more clauses herein, wherein the reservoir includes a passageway formed into a housing at which the reservoir is positioned, wherein the passageway receives the water supply conduit indented into the housing.

120. The ice maker appliance of any one or more clauses herein, wherein the cabinet includes an articulatable panel extending along a side of the cabinet corresponding to the passageway formed into the housing.

121. An ice maker appliance, the ice maker appliance including a cabinet including a plurality of walls forming an interior, wherein at least one of the plurality of walls includes an articulatable panel; an ice engine including a water supply opening; a housing including a body positioned at the interior of the cabinet, the body including a side wall and a base wall, wherein a supply inlet opening and an ice engine supply opening are formed through the body, and wherein the side wall and the base wall form a receiving plenum at which water is received from the supply inlet opening; a water supply conduit fluidly coupling the reservoir to the ice engine, wherein the water supply conduit fluidly couples from the ice engine supply opening to the water supply opening, and wherein the articulatable panel extends substantially alongside the body, the articulatable panel configured to provide access to the interior of the cabinet.

122. The ice maker appliance of any one or more clauses herein, wherein the housing includes a passageway formed into the housing, wherein the passageway is indented into the housing to receive the water supply conduit.

123. The ice maker appliance of any one or more clauses herein, wherein the articulatable panel extends along a side of the cabinet corresponding to the passageway formed into the housing.

124. The ice maker appliance of any one or more clauses herein, wherein at least 50% of a length of the water supply conduit is received into the passageway at the housing.

125. The ice maker appliance of any one or more clauses herein, wherein the articulatable panel is detachable from the cabinet to provide access to the interior of the cabinet.

126. The ice maker appliance of any one or more clauses herein, including a reservoir supply conduit fluidly coupling the housing to a main water supply and a flow control device, wherein the flow control device is operably coupled to a water level sensor configured to determine a water height at the reservoir, the flow control device operably coupled to the water level sensor to selectively permit flow of water through the reservoir supply conduit to the reservoir based on the water height at the reservoir.

127. The ice maker appliance of any one or more clauses herein, including a water filter positioned at a water filter plenum formed at the housing, the water filter positioned fluidly upstream of the ice engine supply opening.

128. The ice maker appliance of any one or more clauses herein, wherein the body forms an upper receiving plenum at which water is received from the supply inlet opening, and wherein the housing includes a lower receiving plenum at which filtered water is received from a drain opening formed at the body.

129. The ice maker appliance of any one or more clauses herein, including an articulatable top panel permitting selective access to the receiving plenum, wherein the top panel couples to the body.

130. The ice maker appliance of any one or more clauses herein, wherein the ice maker appliance includes a nugget ice maker appliance.

131. An ice maker appliance, the ice maker appliance including a cabinet including a plurality of walls forming an interior, wherein at least one of the plurality of walls includes an articulatable panel; an ice engine including a water supply opening; a lower reservoir including a supply outlet opening; an upper reservoir including a body, the body including a side wall and a base wall, wherein a supply inlet opening, and an ice engine supply opening are formed through the body, and wherein the body forms a receiving plenum at which water is received from the supply inlet opening, and wherein the upper reservoir includes an articulatable top panel permitting selective access to the receiving plenum, wherein the top panel couples to the body; a water supply conduit fluidly coupling the upper reservoir to the ice engine, wherein the water supply conduit fluidly couples from the ice engine supply opening to the water supply opening; and an upper reservoir supply conduit fluidly coupling the lower reservoir to the upper reservoir, wherein the upper reservoir supply conduit fluidly couples from the supply outlet opening to the supply inlet opening, and wherein a flow control device is configured to selectively feed water through the upper reservoir supply conduit from the lower reservoir to the upper reservoir, wherein the articulatable panel extends substantially alongside the body, the articulatable panel configured to provide access to the interior of the cabinet, and wherein the upper reservoir is positioned in the interior of the cabinet.

132. The ice maker appliance of any one or more clauses herein, including a housing including the upper reservoir and the lower reservoir, wherein the housing includes a passageway formed into the housing, and wherein the passageway is indented into the housing to receive the water supply conduit.

133. The ice maker appliance of any one or more clauses herein, wherein the articulatable panel extends along a side of the cabinet corresponding to the passageway formed into the housing.

134. The ice maker appliance of any one or more clauses herein, wherein at least 50% of a length of the water supply conduit is received into the passageway at the housing.

135. The ice maker appliance of any one or more clauses herein, wherein the articulatable panel is detachable from the cabinet to provide access to the interior of the cabinet.

136. The ice maker appliance of any one or more clauses herein, wherein the flow control device is received directly onto the lower reservoir at the supply outlet opening, wherein the upper reservoir supply conduit fluidly couples the lower reservoir to the upper reservoir, and wherein the upper reservoir supply conduit fluidly couples from the supply outlet opening to the supply inlet opening.

137. The ice maker appliance of any one or more clauses herein, including a water filter positioned at a water filter plenum formed at the upper reservoir, the water filter positioned fluidly upstream of the ice engine supply opening.

138. The ice maker appliance of any one or more clauses herein, including a water filter positioned at a water filter plenum formed at the upper reservoir, the water filter positioned fluidly upstream of a drain opening at the upper reservoir.

139. The ice maker appliance of any one or more clauses herein, including an articulatable top panel permitting selective access to a receiving plenum at the upper reservoir, wherein the top panel couples to the body, and wherein a water filter is positioned at a water filter plenum formed at the upper reservoir.

140. The ice maker appliance of any one or more clauses herein, the cabinet including a plurality of walls forming the interior, wherein at least one of the plurality of walls includes an articulatable door, wherein the articulatable door provides selective access to a storage volume extending from the door to a portion of the interior of the cabinet.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An ice maker appliance, the ice maker appliance comprising:
a cabinet comprising a plurality of walls forming an interior, wherein at least one of the plurality of walls comprises an articulatable door;
an ice engine comprising a water supply opening;
a reservoir comprising a body, the body comprising a side wall and a base wall, wherein a supply inlet opening and an ice engine supply opening are formed through the body, and wherein the body forms a receiving plenum at which water is received from the supply inlet opening, and wherein the reservoir is at least partially housed at the interior of the cabinet;
a water level sensor configured to determine a water height at the reservoir;
a water supply conduit fluidly coupling the reservoir to the ice engine, wherein the water supply conduit fluidly couples from the ice engine supply opening to the water supply opening;
a water filter positioned at the reservoir, wherein the water filter is positioned fluidly upstream of the water supply conduit and the ice engine supply opening; and
a reservoir supply conduit fluidly coupling the reservoir to a main water supply and a flow control device, wherein the flow control device is operably coupled to the water level sensor to selectively permit flow of water through the reservoir supply conduit to the reservoir based on the water height at the reservoir.

2. The ice maker appliance of claim 1, wherein the articulatable door provides selective access to a storage volume extending from the door to a portion of the interior of the cabinet.

3. The ice maker appliance of claim 1, the ice maker appliance comprising:
an ice storage vessel configured to receive ice produced from the ice engine.

4. The ice maker appliance of claim 3, wherein the articulatable door is positioned beneath the ice storage vessel.

5. The ice maker appliance of claim 1, wherein the articulatable door is positioned at a front face of the plurality of walls of the cabinet.

6. The ice maker appliance of claim 1, the ice maker appliance comprising:
a valve configured to selectively discharge water from the reservoir, wherein a drain conduit fluidly couples the valve to a drain opening at the reservoir.

7. The ice maker appliance of claim 6, wherein the valve configured to selectively discharge water from the reservoir is mounted to a side wall of the plurality of walls of the cabinet.

8. The ice maker appliance of claim 1, wherein the water filter is positioned fluidly between the receiving plenum and a filtered water plenum.

9. The ice maker appliance of claim 8, wherein the reservoir comprises a drain opening at the filtered water plenum.

10. The ice maker appliance of claim 9, the ice maker appliance comprising:
a valve configured to selectively discharge water from the reservoir, wherein a drain conduit fluidly couples the valve to the drain opening at the filtered water plenum of the reservoir.

11. The ice maker appliance of claim 1, wherein the reservoir comprises a passageway formed into a housing at which the reservoir is positioned, wherein the passageway receives the water supply conduit indented into the housing.

12. The ice maker appliance of claim 11, wherein the cabinet comprises an articulatable panel extending along a side of the cabinet corresponding to the passageway formed into the housing.

13. The ice maker appliance of claim 12, wherein the articulatable panel is detachable from the cabinet to provide access to the interior of the cabinet.

14. An ice maker appliance, the ice maker appliance comprising:
a cabinet comprising a plurality of walls forming an interior, wherein at least one of the plurality of walls comprises an articulatable door;
an ice engine comprising a water supply opening;
a reservoir comprising a body, the body comprising a side wall and a base wall, wherein a supply inlet opening, a drain opening, and an ice engine supply opening are formed through the body, and wherein the body forms an upper receiving plenum at which water is received from the supply inlet opening, and wherein the reservoir is at least partially housed at the interior of the cabinet;
a water level sensor configured to determine a water height at the reservoir;
a water supply conduit fluidly coupling the reservoir to the ice engine, wherein the water supply conduit fluidly couples from the ice engine supply opening to the water supply opening;
a water filter positioned at the reservoir, the water filter positioned fluidly between the upper receiving plenum and the drain opening, and wherein the drain opening is fluidly coupled to a lower receiving plenum at which filtered water is received from the drain opening; and
a reservoir supply conduit fluidly coupling the reservoir to a main water supply and a flow control device, wherein the flow control device is operably coupled to the water level sensor to selectively permit flow of water through the reservoir supply conduit to the reservoir based on the water height at the reservoir.

15. The ice maker appliance of claim 14, wherein the articulatable door provides selective access to a storage volume extending from the door to a portion of the interior of the cabinet.

16. The ice maker appliance of claim 14, the ice maker appliance comprising:
an ice storage vessel configured to receive ice produced from the ice engine, wherein the articulatable door is positioned beneath the ice storage vessel.

17. The ice maker appliance of claim 14, wherein the articulatable door is positioned at a front face of the plurality of walls of the cabinet.

18. The ice maker appliance of claim 14, wherein the body of the reservoir forms an integral, unitary, monolithic component comprising the upper receiving plenum, a water filter plenum at which the water filter is positioned, and the lower receiving plenum.

19. The ice maker appliance of claim 11, wherein the reservoir comprises a passageway formed into a housing at which the reservoir is positioned, wherein the passageway receives the water supply conduit indented into the housing.

20. The ice maker appliance of claim 19, wherein the cabinet comprises an articulatable panel extending along a side of the cabinet corresponding to the passageway formed into the housing.
